(19) United States
(12) Patent Application Publication
(10) Pub. No.: US 2025/0350230 A1
(43) Pub. Date: Nov. 13, 2025

(54) CONTROL DEVICE, MOTOR MODULE, AND CONTROL METHOD

(71) Applicant: NIDEC CORPORATION, Kyoto (JP)

(72) Inventors: Takahiro NAKAGAWA, Kyoto (JP); Tomohiro FUKUMURA, Kyoto (JP)

(21) Appl. No.: 18/727,104

(22) PCT Filed: Jan. 10, 2023
(86) PCT No.: PCT/JP2023/000285

§ 371 Date: Nov. 29, 2024

(30) Foreign Application Priority Data
Jan. 14, 2022 (JP) 2022-004365

(51) Int. Cl. H02P 29/024

(52) U.S. Cl. CPC H02P 29/027

(57) ABSTRACT

A control device controls an N-phase inverter when N is an integer of three or more. The control device includes a low-pass filter, a current detection unit, and an averaging processing unit. The low-pass filter has a frequency characteristic corresponding to a time constant. The current detection unit detects current flowing through an electric resistance unit connected between a DC power supply unit and the N-phase inverter via the low-pass filter. The averaging processing unit executes averaging processing on a current value of the current detected by the current detection unit at a plurality of current detection times.

### RELATED APPLICATIONS

The present application is a National Phase of International Application No. PCT/JP2023/000285 filed Jan. 10, 2023, which claims priority to Japanese Application No. 2022-004365, filed Jan. 14, 2022.

### TECHNICAL FIELD

The present disclosure relates to a control device, a motor module, and a control method.

### BACKGROUND ART

Conventionally, a motor drive device is known (for example, Patent Literature 1). In a conventional motor drive device, in order to drive a three-phase DC motor with appropriate torque, a current control unit uses a current detection value detected by a DC shunt resistor, controls duty of PWM so that the current detection value matches a current command, and outputs PWMCLK. Motor drive current detected by a DC shunt resistor is amplified by a sense amplifier and converted into a digital value at high speed by an analog-to-digital converter (hereinafter, referred to as Δ-ΣADC). In output of the Δ-ΣADC, a PWM frequency component is removed by a moving average filter having a transmission zero point at a PWM frequency, and this output Ips is used for current error detection.

### CITATIONS LIST

### Patent Literature

Patent Literature 1: JP 2009-50132 A

### SUMMARY OF INVENTION

### Technical Problems

However, in the conventional motor drive device, the Δ-ΣADC (current detection unit) is a high-speed ADC (20 MHz). Therefore, in a case where a high-speed ADC is not used, a detection error of an effective value of motor drive current may become large. In other words, detection accuracy of an effective value of motor drive current depends on performance of an ADC.

The present disclosure has been made in view of the above problem, and an object of the present disclosure is to provide a control device, a motor module, and a control method capable of accurately detecting an effective value of power supply current from a DC power supply unit while reducing dependency on performance of a current detection unit.

### Solutions to Problems

An exemplary control device of the present disclosure controls an N-phase inverter when N is an integer of three or more. The control device includes a low-pass filter, a current detection unit, and an averaging processing unit. The low-pass filter has a frequency characteristic corresponding to a time constant. The current detection unit detects current flowing through an electric resistance unit connected between a DC power supply unit and the N-phase inverter via the low-pass filter. The averaging processing unit executes averaging processing on a current value of the current detected by the current detection unit at a plurality of current detection times.

An exemplary motor module of the present disclosure includes the control device and a motor. The motor is driven by an N-phase inverter controlled by the control device when N is an integer of three or more.

An exemplary control method of the present disclosure is executed by a control device that controls an N-phase inverter when N is an integer of three or more. The control method includes a current detection step of detecting, via a low-pass filter, current flowing through an electric resistance unit connected between a DC power supply unit and the N-phase inverter, and an averaging processing step of executing averaging processing on a current value of the current detected by the current detection step at a plurality of current detection times.

### Advantageous Effects of Invention

According to the exemplary present disclosure, it is possible to accurately detect an effective value of power supply current from a DC power supply unit while reducing dependency on performance of a current detection unit.

### BRIEF DESCRIPTION OF DRAWINGS

FIG. 1 is a block diagram illustrating a motor module according to a first embodiment of the present disclosure.

FIG. 2 is a circuit diagram illustrating a three-phase inverter according to the first embodiment.

FIG. 3 is a diagram illustrating waveforms of a carrier wave, a compare value, a first gate signal, and U-phase voltage in the first embodiment.

FIG. 4 is a diagram illustrating an example of a waveform of voltage applied to each phase of a three-phase motor, a waveform of current flowing through an electric resistance unit, and a waveform of current passing through a low-pass filter in the first embodiment (three-phase modulation method).

FIG. 5 is an enlarged diagram of a region A1 in FIG. 4.

FIG. 6 is an enlarged diagram of a region A2 in FIG. 5.

FIG. 7 is a diagram schematically illustrating a fluctuation component of current flowing through the electric resistance unit according to the first embodiment.

FIG. 8 is a diagram for explaining operation of a control device according to a first comparative example.

FIG. 9 is a diagram schematically illustrating a waveform of current flowing through the electric resistance unit and a waveform of current passing through the low-pass filter in the first embodiment.

FIG. 10 is a diagram schematically illustrating a waveform of current flowing through the electric resistance unit and a waveform of current passing through the low-pass filter having a phase delayed by about 90 degrees in the first embodiment.

FIG. 11 is a table illustrating a time constant of the low-pass filter, a phase delay angle of a fluctuation component of current passing through the low-pass filter, and an error of a detection value of a power supply current effective value in the embodiment of the present disclosure.

FIG. 12A is a graph illustrating a relationship between a phase delay angle of a fluctuation component of current passing through the low-pass filter and an error of a detection value of a power supply current effective value in the embodiment of the present disclosure.

FIG. 12B is a graph illustrating a relationship between a time constant of the low-pass filter and an error of a detection value of a power supply current effective value in the embodiment of the present disclosure.

FIG. 13 is a diagram for explaining an example of moving average processing by an averaging processing unit according to the first embodiment.

FIG. 14 is a circuit diagram illustrating an example of the low-pass filter and an amplification unit according to the first embodiment.

FIG. 15 is a diagram illustrating an example of a waveform of voltage applied to each phase of the three-phase motor, a waveform of current flowing through the electric resistance unit, and a waveform of current passing through the low-pass filter in a first variation (two-phase modulation min-type in-phase modulation system) of the first embodiment.

FIG. 16 is an enlarged diagram of a region C1 in FIG. 15.

FIG. 17 is an enlarged diagram of a region C2 in FIG. 16.

FIG. 18 is a diagram for explaining operation of the control device according to a second comparative example.

FIG. 19 is a diagram schematically illustrating a waveform of current flowing through the electric resistance unit and a waveform of current passing through the low-pass filter in the first variation.

FIG. 20 is a diagram schematically illustrating a waveform of current flowing through the electric resistance unit and a waveform of current passing through the low-pass filter having a phase delayed by about 90 degrees in the first variation.

FIG. 21 is a diagram illustrating an example of a waveform of voltage applied to each phase of the three-phase motor, a waveform of current flowing through the electric resistance unit, and a waveform of current passing through the low-pass filter in a first variation (two-phase modulation min-type reverse-phase modulation system) of a second embodiment.

FIG. 22 is an enlarged diagram of a region D1 in FIG. 21.

FIG. 23 is an enlarged diagram of a region D2 in FIG. 22.

FIG. 24 is a diagram for explaining operation of the control device according to a third comparative example.

FIG. 25 is a diagram schematically illustrating a waveform of current flowing through the electric resistance unit and a waveform of current passing through the low-pass filter in a second variation.

FIG. 26 is a diagram schematically illustrating a waveform of current flowing through the electric resistance unit and a waveform of current passing through the low-pass filter having a phase delayed by about 90 degrees in the second variation.

FIG. 27 is a block diagram illustrating a motor module according to a second embodiment of the present disclosure.

FIG. 28 is a flowchart illustrating a control method according to the second embodiment.

### DESCRIPTION OF EMBODIMENTS

Hereinafter, an embodiment of the present disclosure will be described with reference to the drawings. In the drawings, the identical or corresponding parts will be denoted by the identical reference signs and description of such parts will not be repeated.

### First Embodiment

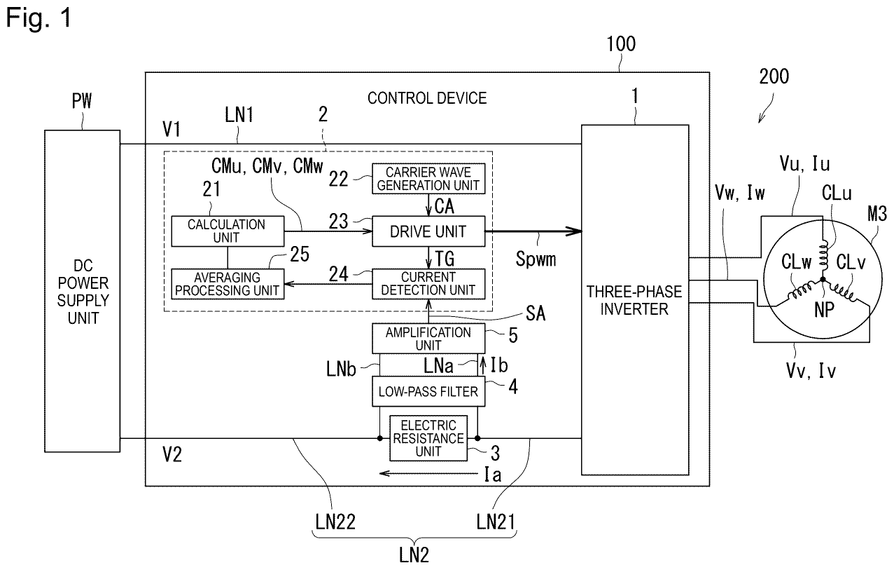

A motor module 200 according to a first embodiment of the present disclosure will be described with reference to FIGS. 1 to 14. FIG. 1 is a block diagram illustrating the motor module 200 according to the first embodiment.

As illustrated in FIG. 1, the motor module 200 includes a control device 100 and a three-phase motor M3. The control device 100 controls a three-phase inverter 1 that applies voltages Vu, Vv, and Vw to three phases. The three phases are a U phase, a V phase, and a W phase. The voltage Vu is U-phase voltage, the voltage Vv is V-phase voltage, and the voltage Vw is W-phase voltage. Hereinafter, the voltages Vu, Vv, and Vw may be referred to as the applied voltages Vu, Vv, and Vw. Further, the voltages Vu, Vv, and Vw may be collectively or individually referred to as “phase voltage”. Note that, in the example of FIG. 1, the control device 100 includes the three-phase inverter 1. Then, the three-phase inverter 1 is connected to a DC power supply unit PW.

In the present description, as an example, the three-phase inverter 1 applies the voltages Vu, Vv, and Vw having different phases to the U phase, the V phase, and the W phase of the three-phase motor M3 to drive the three-phase motor M3. Currents Iu, Iv, and Iw corresponding to the voltages Vu, Vv, and Vw flow through the U phase, the V phase, and the W phase of the three-phase motor M3. The current Iu is U-phase current, the current Iv is V-phase current, and the current Iw is W-phase current. Hereinafter, the currents Iu, Iv, and Iw may be collectively or individually referred to as “phase current”.

The three-phase motor M3 has a U phase, a V phase, and a W phase. That is, the three-phase motor M3 includes coils CLu, CLv, and CLw of three phases. The coil CLu is a U-phase coil, the coil CLv is a V-phase coil, and the coil CLw is a W-phase coil. The three-phase motor M3 is, for example, a brushless DC motor. The currents Iu, Iv, and Iw flow through the coils CLu, CLv, and CLw, respectively. Note that, regarding polarity of the currents Iu, Iv, and Iw, polarity of current in a direction flowing from the three-phase inverter 1 to a neutral point NP of the three-phase motor M3 is set to positive, and polarity of current in a direction flowing from the neutral point NP to the three-phase inverter 1 is set to negative.

Note that a driving target of the three-phase inverter 1 is not limited to the three-phase motor M3, and may be another electric device. Further, the three-phase inverter 1 may be arranged outside the control device 100.

The control device 100 further includes an electric resistance unit 3, a low-pass filter 4, a current detection unit 24, and an averaging processing unit 25. Specifically, the control device 100 includes an inverter control unit 2. The inverter control unit 2 controls the three-phase inverter 1. Then, the inverter control unit 2 includes the current detection unit 24 and the averaging processing unit 25.

The electric resistance unit 3 is a resistance component (for example, a resistance element) for detecting an effective value (hereinafter, referred to as “power supply current effective value”) of power supply current from a DC power supply unit PW via the three-phase inverter 1. In the first embodiment, the electric resistance unit 3 is used as a current sensor, so that the control device 100 can be realized at low cost. The electric resistance unit 3 is, for example, a shunt resistor.

The low-pass filter 4 has a frequency characteristic corresponding to a time constant τ. That is, the low-pass filter 4 allows a frequency component lower than a cutoff frequency fc (=½πτ) to pass through and attenuates a frequency component higher than the cutoff frequency fc. The low-pass filter 4 is arranged at a preceding stage of the current detection unit 24. The current detection unit 24 detects current Ia flowing through the electric resistance unit 3 connected between the DC power supply unit PW and the three-phase inverter 1 via the low-pass filter 4. That is, the current detection unit 24 indirectly detects the current Ia via the low-pass filter 4. Specifically, the current detection unit 24 detects, via the low-pass filter 4, a potential difference between both ends of the electric resistance unit 3 through which the current Ia flows. A potential difference between both ends of the electric resistance unit 3 is generated by a voltage drop by the electric resistance unit 3. The current detection unit 24 converts a potential difference between both ends of the electric resistance unit 3 into current to acquire a current value of the current Ia.

The averaging processing unit 25 executes averaging processing on a current value of the current Ia detected by the current detection unit 24 at a plurality of current detection times. Therefore, influence of a fluctuation component included in the current Ia can be reduced. Directly, influence of a fluctuation component included in current Ib that passes through the low-pass filter 4 can be reduced by averaging processing. As a result, according to the first embodiment, the control device 100 can accurately detect a power supply current effective value while reducing dependency on performance of the current detection unit 24. That is, in a case where performance of the current detection unit 24 is relatively low, a power supply current effective value can be accurately detected. A current value of the current Ia after averaging processing corresponds to a power supply current effective value.

For example, the control device 100 can accurately detect a power supply current effective value while reducing dependency on a sampling frequency of the current detection unit 24. That is, the control device 100 can accurately detect a power supply current effective value when a sampling frequency of the current detection unit 24 is relatively low (for example, 10 kHz to 40 kHz).

Further, according to the first embodiment, both stability and followability at the time of detection of a power supply current effective value can be realized.

Details of stability are as described below. Since the averaging processing unit 25 executes averaging processing on a current value of the current Ia detected via the low-pass filter 4, an average value substantially indicates a power supply current effective value in a case where phase current flows through the electric resistance unit 3. In other words, in a case where phase current flows through the electric resistance unit 3, a power supply current effective value can be detected by use of one of the electric resistance unit 3. Further, in a case where the current Ia flowing through the electric resistance unit 3 includes a fluctuation component, an average value substantially indicates a power supply current effective value. That is, in a case where the current Ia includes a fluctuation component, a power supply current effective value can be detected using one of the electric resistance unit 3. In other words, stability at the time of detecting a power supply current effective value can be improved.

Details of the followability are as described below. Since the averaging processing unit 25 executes averaging processing on a current value of the current Ia detected via the low-pass filter 4, in a case where the time constant τ of the low-pass filter 4 is set to be relatively short, a power supply current effective value can be detected using one of the electric resistance unit 3. In other words, while a response characteristic of the low-pass filter 4 is improved, a power supply current effective value can be detected using one of the electric resistance unit 3. Therefore, in a case where power supply current from the DC power supply unit PW suddenly changes, detection operation of the current Ia by the current detection unit 24 can follow the sudden change in the power supply current. In other words, followability at the time of detection of the current Ia can be improved. In still other words, followability at the time of detection of a power supply current effective value can be improved. For example, when the time constant τ of the low-pass filter 4 is set to be relatively short, in a case where overcurrent occurs in the control device 100, time from occurrence of the overcurrent until a detection value of the current Ia by the current detection unit 24 increases can be shortened. That is, detection time for overcurrent can be shortened.

Here, the averaging processing is processing of calculating an average value of current values of the currents Ia detected at a plurality of current detection times. The averaging processing may be executed by software or hardware. Hereinafter, current detection times may be collectively or individually referred to as a current detection time td.

Preferably, the averaging processing is moving average processing. That is, preferably, the averaging processing unit 25 executes moving average processing on current values of the current Ia detected at a plurality of the current detection times td. Therefore, according to the first embodiment, in a case where the relatively short time constant τ is set for the low-pass filter 4, a power supply current effective value can be detected more accurately. That is, followability and stability at the time of detecting a power supply current effective value can be further improved.

The moving average processing is processing of calculating an average value of current values of the currents Ia detected at a plurality of the current detection times td by a moving average. The moving average is, for example, a simple moving average or a weighted moving average. Details of the moving average processing will be described later.

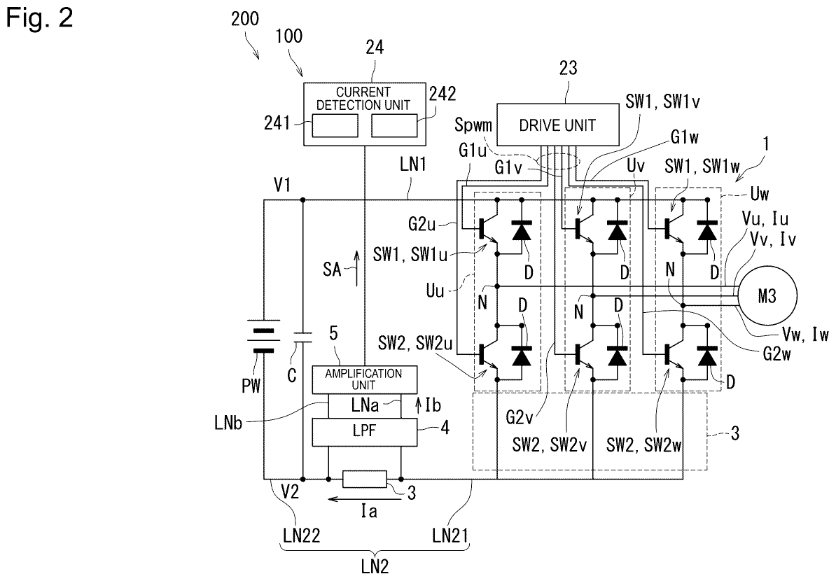

Next, a drive unit 23 and the three-phase inverter 1 will be described with reference to FIGS. 1 and 2. As illustrated in FIG. 1, the inverter control unit 2 further includes the drive unit 23. The drive unit 23 outputs a pulse width modulation (PWM) signal Spwm to the three-phase inverter 1. As a result, the three-phase inverter 1 is driven by the PWM signal Spwm.

FIG. 2 is a circuit diagram illustrating the three-phase inverter 1. As illustrated in FIG. 2, the PWM signal Spwm output from the drive unit 23 includes first gate signals G1u, G1v, and G1w and second gate signals G2u, G2v, and G2w. Note that the first gate signals G1u, G1v, and G1w may be collectively or individually simply referred to as “first gate signal”. Further, the second gate signals G2u, G2v, and G2w may be collectively or individually simply referred to as “second gate signal”.

The three-phase inverter 1 includes three switching units Uu, Uv, and Uv. The switching units Uu, Uv, and Uv apply the voltages Vu, Vv, and Vw to three phases. Specifically, the switching units Uu, Uv, and Uv respectively apply the voltages Vu, Vv, and Vw having different phases to the coils CLu, CLv, and CLw of three phases (FIG. 1).

The switching units Uu, Uv, and Uv are connected in parallel between a first power supply line LN1 and a second power supply line LN2.

First voltage V1 is supplied from the DC power supply unit PW to the first power supply line LN1. The first power supply line LN1 extends from a terminal on the first voltage V1 side of the DC power supply unit PW to the high voltage side of the three-phase inverter 1. Second voltage V2 is supplied from the DC power supply unit PW to the second power supply line LN2. In an example of FIG. 2, the second voltage V2 is smaller than the first voltage V1. Typically, the second voltage V2 is ground voltage (0 V). The second power supply line LN2 extends from a terminal on the second voltage V2 side of the DC power supply unit PW to the low-voltage side of the three-phase inverter 1.

The second power supply line LN2 includes a line LN21 and a line LN22. The line LN21 connects one terminal of the electric resistance unit 3 and the low voltage side of the switching units Uu, Uv, and Uv. The line LN22 connects the other terminal of the electric resistance unit 3 and a terminal on the second voltage V2 side of the DC power supply unit PW. Therefore, the second voltage V2 is supplied to the other terminal of the electric resistance unit 3.

Each of the switching units Uu, Uv, and Uv includes a first switching element SW1 on the first voltage V1 side of the DC power supply unit PW and a second switching element SW2 on the second voltage V2 side of the DC power supply unit PW. The second switching element SW2 is connected in series with the first switching element SW1. Specifically, the first switching element SW1 and the second switching element SW2 are connected in series between the first power supply line LN1 and the second power supply line LN2. More specifically, the first switching element SW1 and the second switching element SW2 are connected in series between the first power supply line LN1 and the line LN21.

Each of the first switching element SW1 and the second switching element SW2 is a semiconductor switching element. In the example of FIG. 2, each of the first switching element SW1 and the second switching element SW2 is an insulated gate bipolar transistor (IGBT). Each of the first switching element SW1 and the second switching element SW2 may be another transistor such as a field effect transistor.

A collector of the first switching element SW1 is connected to the first power supply line LN1. An emitter of the first switching element SW1 and a collector of the second switching element SW2 are connected at a connection point N. An emitter of the second switching element SW2 is connected to the second power supply line LN2. Specifically, the emitter of the second switching element SW2 is connected to the line LN21. Therefore, the emitter of the second switching element SW2 is connected to one terminal of the electric resistance unit 3 by the line LN21.

The connection point N of the switching unit Uu is connected to the coil CLu (FIG. 1) of the three-phase motor M3. The connection point N of the switching unit Uv is connected to the coil CLv (FIG. 1) of the three-phase motor M3. The connection point N of the switching unit Uw is connected to the coil CLw (FIG. 1) of the three-phase motor M3.

Hereinafter, the first switching element SW1 and the second switching element SW2 of the switching unit Uu may be referred to as a first switching element SW1u and a second switching element SW2u, respectively. The first switching element SW1 and the second switching element SW2 of the switching unit Uv may be referred to as a first switching element SW1v and a second switching element SW2v, respectively. The first switching element SW1 and the second switching element SW2 of the switching unit Uw may be referred to as a first switching element SW1w and a second switching element SW2w, respectively.

The first gate signals G1u, G1v, and G1w are input to gates of the first switching elements SW1u, SW1v, and SW1w, respectively. The first switching elements SW1u, SW1v, and SW1w are turned on in a case where the first gate signals G1u, G1v, and G1w are at a high level, respectively. The first switching elements SW1u, SW1v, and SW1w are turned off in a case where the first gate signals G1u, G1v, and G1w are at a low level, respectively.

The second gate signals G2u, G2v, and G2w are input to gates of the second switching elements SW2u, SW2v, and SW2w, respectively. The second switching elements SW2u, SW2v, and SW2w are turned on in a case where the second gate signals G2u, G2v, and G2w are at a high level, respectively. The second switching elements SW2u, SW2v, and SW2w are turned off in a case where the second gate signals G2u, G2v, and G2w are at a low level, respectively.

Polarity of the second gate signals G2u, G2v, and G2w is basically opposite to polarity of the first gate signals G1u, G1v, and G1w, respectively. That is, the second gate signals G2u, G2v, and G2w and the first gate signals G1u, G1v, and G1w basically have a complementary relationship. However, regarding the first gate signals G1u, G1v, and G1w and the second gate signals G2u, G2v, and G2w, a period (dead time) in which both the first gate signal and the second gate signal are at a low level may be provided when each of the first switching element SW1 and the second switching element SW2 is switched on and off. A reason for providing the dead time is to prevent a short circuit between the first power supply line LN1 and the second power supply line LN2 due to influence of rise time and fall time required for each of the first switching element SW1 and the second switching element SW2.

The rectifier element D is connected in parallel to each of the first switching element SW1 and the second switching element SW2 with the first power supply line LN1 side as a cathode and the second power supply line LN2 side as an anode. In a case where a field effect transistor is used as the first switching element SW1 and the second switching element SW2, a parasitic diode may be used as a rectifier element.

The electric resistance unit 3 is arranged on the second power supply line LN2. Specifically, the electric resistance unit 3 is arranged between the three-phase inverter 1 and the DC power supply unit PW in the second power supply line LN2.

The low-pass filter 4 is arranged with respect to the electric resistance unit 3. Specifically, the low-pass filter 4 is connected to one terminal and the other terminal of the electric resistance unit 3. Then, the low-pass filter 4 performs filtering on voltage on both ends of the electric resistance unit 3, allows a frequency component lower than the cutoff frequency fc to pass through, and attenuates a frequency component higher than the cutoff frequency fc. The current Ib is current that flows into the low-pass filter 4 from the line LN21 to which one terminal of the electric resistance unit 3 is connected, and passes through the low-pass filter 4.

The control device 100 further includes an amplification unit 5. Then, the amplification unit 5 amplifies a potential difference output from the low-pass filter 4, and outputs an amplified signal SA to the current detection unit 24. The amplified signal SA is a signal obtained by amplifying a potential difference output from the low-pass filter 4. A potential difference output from the low-pass filter 4 indicates a potential difference between both ends of the electric resistance unit 3. However, a potential difference output from the low-pass filter 4 has a frequency component lower than the cutoff frequency fc of the low-pass filter 4 and does not have a frequency component higher than the cutoff frequency fc.

The current detection unit 24 converts a voltage value indicated by the amplified signal SA into a current value, and outputs the current value to the averaging processing unit 25 (FIG. 1). The current value indicates a current value of the current Ia flowing through the electric resistance unit 3. Typically, the current detection unit 24 is realized by an A/D converter (analog-to-digital converter (ADC)).

Specifically, the current detection unit 24 includes a sample hold unit 241 and a detection unit 242.

The sample hold unit 241 ends sampling of the amplified signal SA when a sampling period Ts elapses from start of the sampling. The sampling period Ts is preset in the current detection unit 24, and is an essential period required for the current detection unit 24 to detect current. The sample hold unit 241 is, for example, a sample hold circuit including an element such as a capacitor.

The detection unit 242 converts the amplified signal SA sampled by the sample hold unit 241 into a digital signal. That is, the detection unit 242 converts the amplified signal SA indicating a potential difference between both ends of the electric resistance unit 3 into a digital signal. Then, the detection unit 242 converts a potential difference between both ends of the electric resistance unit 3 indicated by a digital signal into a current value. In this manner, the detection unit 242 detects the current Ia flowing through the electric resistance unit 3. The detection unit 242 is, for example, an analog-to-digital converter.

Note that the detection unit 242 may output a digital signal indicating the amplified signal SA to the averaging processing unit 25. In this case, the averaging processing unit 25 converts a potential difference between both ends of the electric resistance unit 3 indicated by a digital signal into a current value. Note that in a case where the averaging processing unit 25 converts a potential difference into a current value, it can be substantially understood that the detection unit 242 detects the current Ia.

The control device 100 further includes a capacitor C. The capacitor C is connected between the first power supply line LN1 and the second power supply line LN2. Specifically, the capacitor C is connected between the first power supply line LN1 and the line LN22. The capacitor C can stabilize power supply current from the DC power supply unit PW.

Returning to FIG. 1, the inverter control unit 2 further includes a calculation unit 21 and a carrier wave generation unit 22 in addition to the drive unit 23, the current detection unit 24, and the averaging processing unit 25. The inverter control unit 2 is, for example, a microcomputer. The microcomputer is, for example, a hardware circuit including a processor such as a central processing unit (CPU), a semiconductor memory, an application specific integrated circuit (ASIC), an A/D converter, and various electronic components.

Specifically, each of the calculation unit 21, the carrier wave generation unit 22, the drive unit 23, and the averaging processing unit 25 may be realized by wired logic in a microcomputer, may be realized by a processor executing a computer program stored in a semiconductor memory, or may be realized by a combination of these.

The calculation unit 21 calculates voltage command values Vbu, Vbv, and Vbw (not illustrated) corresponding to a U phase, a V phase, and a W phase, respectively.

The voltage command values Vbu, Vbv, and Vbw indicate voltage values of the voltages Vu, Vv, and Vw output from the three-phase inverter 1, respectively. Therefore, the voltage command values Vbu, Vbv, and Vbw substantially coincide with voltage values of the voltages Vu, Vv, and Vw output from the three-phase inverter 1, respectively. Specifically, the voltage command values Vbu, Vbv, and Vbw indicate voltage values to be followed by the voltages Vu, Vv, and Vw respectively applied to a U phase, a V phase, and a W phase. In the present description, the voltage command values Vbu, Vbv, and Vbw and the applied voltages Vu, Vv, and Vw are substantially synonymous.

The calculation unit 21 calculates compare values CMu, CMv, and CMw based on the voltage command values Vbu, Vbv, and Vbw. Therefore, the compare values CMu, CMv, and CMw correspond to the voltage command values Vbu, Vbv, and Vbw, respectively. The compare values CMu, CMv, and CMw directly or indirectly indicate duty values of the first gate signals G1u, G1v, and G1w in the PWM signal Spwm, respectively. Specifically, a duty value indicates a ratio of ON time of the first switching element SW1 of each phase to a preset PWM period Tpwm. The PWM period Tpwm is a period of the PWM signal Spwm. Specifically, the PWM period Tpwm is a period of the first gate signals G1u, G1v, and G1w and the second gate signals G2u, G2v, and G2w. The calculation unit 21 outputs the compare values CMu, CMv, and CMw to the drive unit 23.

The carrier wave generation unit 22 generates a carrier wave CA. Specifically, the carrier wave generation unit 22 generates the carrier wave CA based on a count value of a timer that operates in synchronization with a clock. The carrier wave generation unit 22 outputs the carrier wave CA to the drive unit 23. The carrier wave CA is, for example, a triangular wave. Note that a waveform of the carrier wave CA is not particularly limited.

The drive unit 23 generates the PWM signal Spwm based on the carrier wave CA and the compare values CMu, CMv, and CMw. Specifically, the drive unit 23 compares each of the compare values CMu, CMv, and CMw with the carrier wave CA, and generates the PWM signal Spwm based on a comparison result. Details will be described later. Then, the drive unit 23 outputs the PWM signal Spwm to the three-phase inverter 1 to drive the three-phase inverter 1. As a result, the three-phase inverter 1 applies the voltages Vu, Vv, and Vw indicated by the voltage command values Vbu, Vbv, and Vbw to the coils CLu, CLv, and CLw of three phases, respectively.

Further, the drive unit 23 generates a trigger TG in synchronization with the carrier wave CA and outputs the trigger TG to the current detection unit 24. The trigger TG indicates arrival of the current detection time td with respect to the current detection unit 24. That is, a time when the trigger TG is generated is the current detection time td. Preferably, the drive unit 23 generates each of the triggers TG at each timing synchronized with a maximum value and a minimum value of the carrier wave CA.

In response to the trigger TG generated by the drive unit 23, the current detection unit 24 detects the current Ia via the electric resistance unit 3, the low-pass filter 4, and the amplification unit 5. Preferably, the current detection unit 24 detects the current Ia via the electric resistance unit 3, the low-pass filter 4, and the amplification unit 5 in response to each of the triggers TG synchronized with a maximum value and a minimum value of the carrier wave CA. That is, the current detection unit 24 preferably detects the current Ia via the electric resistance unit 3, the low-pass filter 4, and the amplification unit 5 at the current detection time td synchronized with a maximum value and a minimum value of the carrier wave CA.

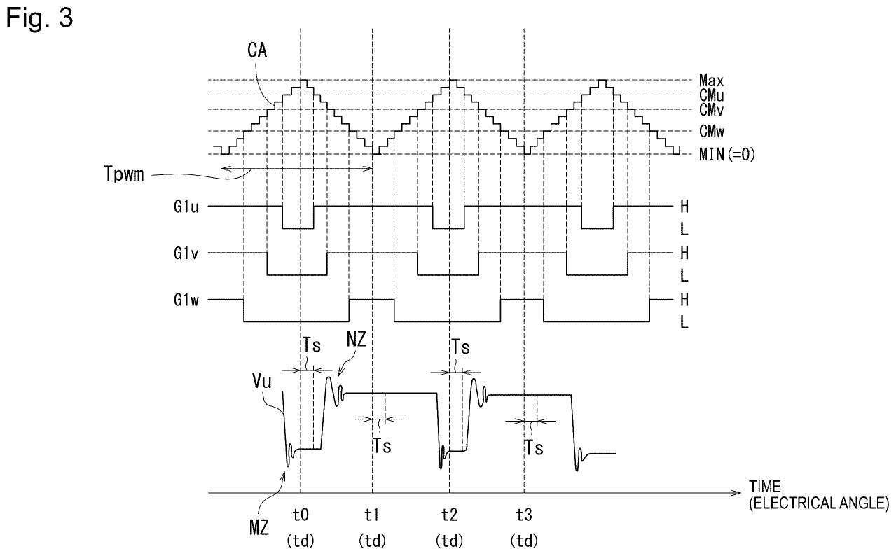

According to this preferred example, the current detection time td can be shifted from a generation timing of switching noise in the three-phase inverter 1. As a result, a power supply current effective value can be detected more accurately. That is, stability at the time of detecting a power supply current effective value can be further improved. This point will be described with reference to FIGS. 2 and 3.

FIG. 3 is a diagram illustrating waveforms of the carrier wave CA, the compare values CMu, CMv, and CMw, the first gate signals G1u, G1v, and G1w, and the voltage Vu. The horizontal axis in FIG. 3 indicates time. Note that, in the present description, an electrical angle can be regarded as representing time by an angle.

As illustrated in FIG. 3, the carrier wave CA is a triangular wave. The triangular wave has a maximum value MAX and a minimum value MIN. In the example of FIG. 3, the minimum value MIN is zero.

The PWM period Tpwm is equal to a period of the carrier wave CA. In the example of FIG. 3, a period from the minimum value MIN of the carrier wave CA to the next minimum value MIN indicates the PWM period Tpwm. The PWM period Tpwm is not limited, and is, for example, 50 μs. Note that a start point and an end point of the PWM period Tpwm are not limited to the minimum value MIN of the carrier wave CA, and can be optionally set.

As illustrated in FIGS. 2 and 3, the drive unit 23 compares the compare value CMu with the carrier wave CA, compares the compare value CMv with the carrier wave CA, and compares the compare value CMw with the carrier wave CA in each of the PWM periods Tpwm. As a result, the first gate signals G1u, G1v, and G1w and the second gate signals G2u, G2v, and G2w are generated. In the first embodiment, as an example, the drive unit 23 generates the first gate signals G1u, G1v, and G1w and the second gate signals G2u, G2v, and G2w by a center alignment method.

In the example of FIG. 3, when the compare value CMu is equal to or more than a level of the carrier wave CA, the drive unit 23 sets the first gate signal G1u to a high level (sets the second gate signal G2u to a low level). On the other hand, in a case where the compare value CMu is less than a level of the carrier wave CA, the drive unit 23 sets the first gate signal G1u to a low level (sets the second gate signal G2u to a high level).

Similarly, in the example of FIG. 3, in a case where the compare value CMv is equal to or more than a level of the carrier wave CA, the drive unit 23 sets the first gate signal G1v to a high level (sets the second gate signal G2v to a low level). On the other hand, in a case where the compare value CMv is less than a level of the carrier wave CA, the drive unit 23 sets the first gate signal G1v to a low level (sets the second gate signal G2v to a high level).

Similarly, in the example of FIG. 3, in a case where the compare value CMw is equal to or more than a level of the carrier wave CA, the drive unit 23 sets the first gate signal G1w to a high level (sets the second gate signal G2w to a low level). On the other hand, in a case where the compare value CMw is less than a level of the carrier wave CA, the drive unit 23 sets the first gate signal G1w to a low level (sets the second gate signal G2w to a high level).

Here, attention is paid to the first gate signal G1u, the first switching element SW1u, the second gate signal G2u, the second switching element SW2u, and the voltage Vu. As illustrated in FIG. 3, at a switching timing at which the first gate signal G1u switches from a high level to a low level and a switching timing at which the first gate signal G1u switches from a low level to a high level, switching noise NZ caused by the first switching element SW1u may be generated in the voltage Vu. Although not illustrated, similarly, at a switching timing at which the second gate signal G2u switches from a low level to a high level and a switching timing at which the second gate signal G2u switches from a high level to a low level, the switching noise NZ caused by the second switching element SW2u may be generated in the voltage Vu. With respect to the first gate signals G1v and G1w and the first switching elements SW1v and SW1w, and the second gate signals G2v and G2w and the second switching elements SW2v and SW2w, switching noise NZ may be generated in the voltages Vv and Vw at a switching timing.

In view of the above, the current detection unit 24 detects the current Ia flowing through the electric resistance unit 3 at a timing (for example, times t0, t1, t2, and t3) different from a switching timing at which the switching noise NZ occurs, so as to reduce influence of the switching noise NZ on a detection result of the current Ia.

A timing different from a switching timing is preferably a timing at which the carrier wave CA becomes the maximum value MAX (for example, the times t0 and t2) and a timing at which the carrier wave CA becomes the minimum value MIN (for example, the times t1 and t3). This is because a timing at which the carrier wave CA becomes the maximum value MAX and a timing at which the carrier wave CA becomes the minimum value MIN are temporally separated from a switching timing of the first switching elements SW1u, SW1v, and SW1w and the second switching elements SW2u, SW2v, and SW2w regardless of the magnitude of the compare values CMu, CMv, and CMw.

In view of the above, the current detection unit 24 detects the current Ia flowing through the electric resistance unit 3 at a timing at which the carrier wave CA becomes the maximum value MAX (for example, the times t0 and t2) and a timing at which the carrier wave CA becomes the minimum value MIN (for example, the times t1 and t3). As a result, influence of the switching noise NZ on a detection result of the current Ia can be more effectively reduced. In the example of FIG. 3, the times t0 to t3 are the current detection time td. Further, in the example of FIG. 3, the current detection time td coincides with a time at which the carrier wave CA becomes the maximum value MAX or a time at which the carrier wave CA becomes the minimum value MIN.

For example, the current detection unit 24 starts detection of the current Ia from the current detection time td. Specifically, the sample hold unit 241 of the current detection unit 24 starts sampling of the amplified signal SA from the current detection time td, and ends the sampling when the sampling period Ts ends. Then, the detection unit 242 converts the amplified signal SA sampled by the sample hold unit 241 into a digital signal.

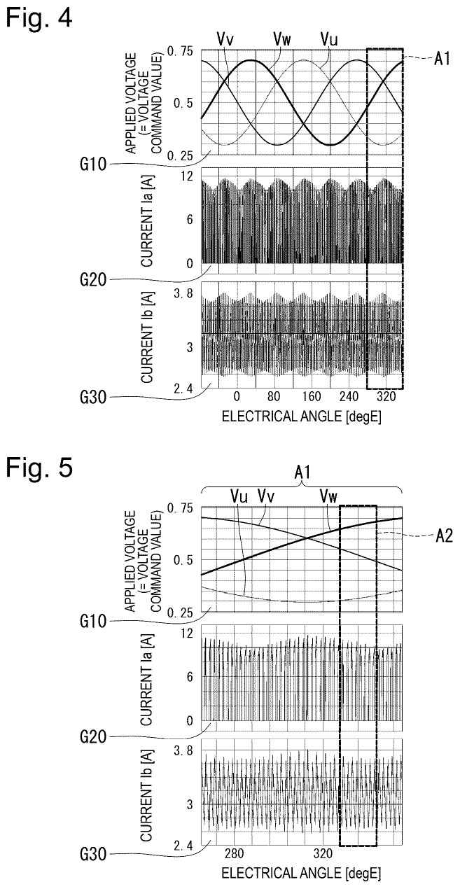

Next, an example of the voltages Vu, Vv, and Vw, the current Ia, and the current Ib when energization in a three-phase modulation system is executed will be described with reference to FIGS. 4 to 6.

FIG. 4 is a diagram illustrating an example of a waveform of the voltages Vu, Vv, and Vw applied to each phase of the three-phase motor M3, a waveform of the current Ia flowing through the electric resistance unit 3, and a waveform of the current Ib passing through the low-pass filter 4.

As illustrated in FIG. 4, a waveform diagram G10 illustrates the voltages Vu, Vv, and Vw applied to each phase. In the waveform diagram G10, the horizontal axis represents an electrical angle [degE], and the vertical axis represents the voltages Vu, Vv, and Vw. For convenience of description, the vertical axis of the waveform diagram G10 represents a voltage value normalized by the input voltages V1 to V2, and the voltages Vu, Vv, and Vw take a value in a range from zero to one. Further, this value also represents a duty value, which is a ratio of ON time of the first switching element SW1 of each phase to the PWM period Tpwm. Therefore, a curve indicating each of the voltages Vu, Vv, and Vw can also be regarded as a curve indicating the compare values CMu, CMv, and CMw.

As illustrated in the waveform diagram G10, the voltages Vu, Vv, and Vw are sinusoidal. Phases of the voltages Vu, Vv, and Vw are different from each other. In the first embodiment, energization in a three-phase modulation system is executed.

A waveform diagram G20 illustrates a waveform of the current Ia. In the waveform diagram G20, the horizontal axis represents an electrical angle [degE], and the vertical axis represents the current Ia [A]. A waveform diagram G30 illustrates a waveform of the current Ib. In the waveform diagram G30, the horizontal axis represents an electrical angle [degE], and the vertical axis represents the current Ib [A].

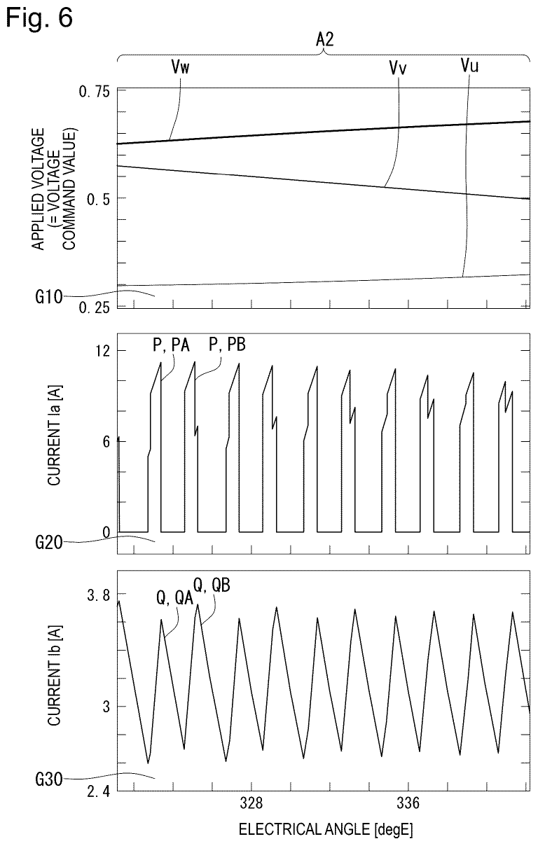

FIG. 5 is an enlarged diagram of a region A1 in FIG. 4. FIG. 6 is an enlarged diagram of a region A2 in FIG. 5. As illustrated in FIGS. 5 and 6, in the current Ib, a high-frequency component is removed from the current Ia by an action of the low-pass filter 4. Further, as illustrated in FIG. 6, the current Ia includes a plurality of fluctuation components P. For example, the current Ia alternately includes a fluctuation component PA and a fluctuation component PB. The fluctuation component P of the current Ia is generated mainly due to switching operation of the first switching element SW1 and the second switching element SW2 illustrated in FIG. 2. Similarly, the current Ib includes a plurality of fluctuation components Q. For example, the current Ib alternately includes a fluctuation component QA and a fluctuation component QB. The fluctuation component QA corresponds to the fluctuation component PA. The fluctuation component QB corresponds to the fluctuation component PB.

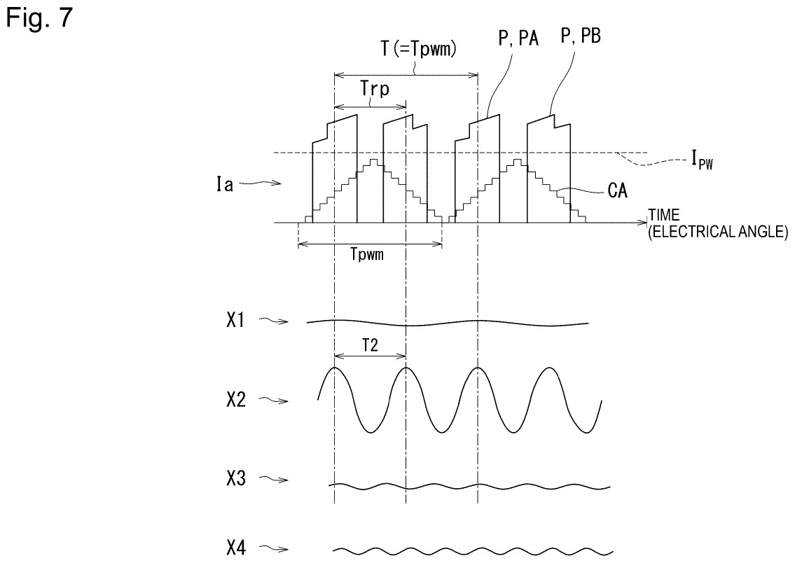

Next, a fluctuation period Trp of the current Ia flowing through the electric resistance unit 3 will be described with reference to FIG. 7. FIG. 7 is a diagram schematically illustrating the fluctuation component P of the current Ia. As illustrated in FIG. 7, the current Ia includes a plurality of the fluctuation components P. For example, the current Ia alternately includes the fluctuation component PA and the fluctuation component PB. FIG. 7 illustrates a theoretical value Ipw of a power supply current effective value.

In the example of FIG. 7, the fluctuation period Trp of the current Ia is ½ of a period T. A length of the period T is the same as a length of the PWM period Tpwm. The fluctuation period Trp indicates a period of the fluctuation component P.

Specifically, the fluctuation period Trp is a period of a term having a largest amplitude among a plurality of terms in a case where a waveform of the current Ia is subjected to Fourier series expansion. That is, the fluctuation period Trp is a period of an order component having a largest amplitude among a plurality of order components in a case where a waveform of the current Ia is subjected to Fourier series expansion.

For example, as illustrated in FIG. 7, when a waveform of the current Ia is subjected to Fourier series expansion, a primary component X1, a secondary component X2, a tertiary component X3, and a quaternary component X4 of the current Ia are derived. A period of a J-th order component is 1/J times the PWM period Tpwm. J is an order and indicates an integer of one or more. In the example of FIG. 7, an amplitude of the secondary component X2 is largest. Therefore, the fluctuation period Trp of the current Ia is a period T2 of the secondary component X2.

Note that a length of a fluctuation period of the current Ib that passes through the low-pass filter 4 is substantially the same as a length of the fluctuation period Trp of the current Ia. A fluctuation period of the current Ib indicates a period of the fluctuation component Q of the current Ib.

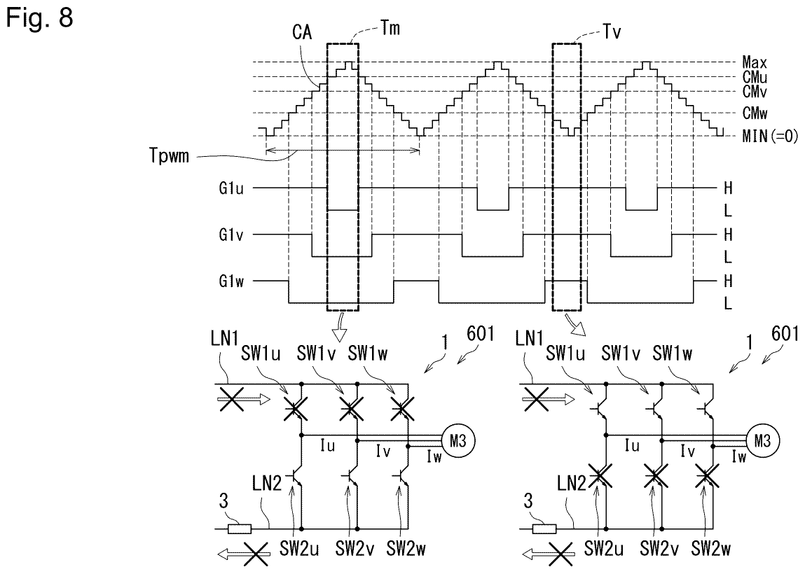

Next, before detailed description of the control device 100 of the first embodiment, a control device 601 according to a first comparative example will be described with reference to FIG. 8 in order to facilitate understanding. As compared with the control device 100 of FIG. 1, the control device 601 does not include the averaging processing unit 25 or the low-pass filter 4. Other configurations of the control device 601 are similar to those of the control device 100. Therefore, in description of each configuration of the control device 601, a reference numeral attached to each configuration of the control device 100 is appropriately used.

FIG. 8 is a diagram for explaining operation of the control device 601 according to the first comparative example. Note that, in FIG. 8, the rectifier element D is omitted for simplification of the diagram.

As illustrated in FIG. 8, in a period Tm including the maximum value MAX of the carrier wave CA, the first gate signals G1u, G1v, and G1w are at a low level. Therefore, in the three-phase inverter 1 of the control device 601, the first switching elements SW1u, SW1v, and SW1w are turned off. Therefore, in the period Tm, no current flows through the electric resistance unit 3.

Further, in a period Tv including the minimum value MIN of the carrier wave CA, the first gate signals G1u, G1v, and G1w are at a high level, and the second gate signals G2u, G2v, and G2w (not illustrated) are at a low level. Therefore, in the three-phase inverter 1 of the control device 601, the second switching elements SW2u, SW2v, and SW2w are turned off. Therefore, in the period Tv, no current flows through the electric resistance unit 3.

That is, in the first comparative example, since the first power supply line LN1 and the second power supply line LN2 are not electrically connected in the periods Tm and Tv, no current flows through the electric resistance unit 3. Therefore, in the periods Tm and Tv, a power supply current effective value cannot be detected.

Therefore, in the first embodiment, the control device 100 includes the low-pass filter 4 and the averaging processing unit 25 to delay a phase of current and execute the averaging processing, so that detection of a power supply current effective value in the periods Tm and Tv is enabled.

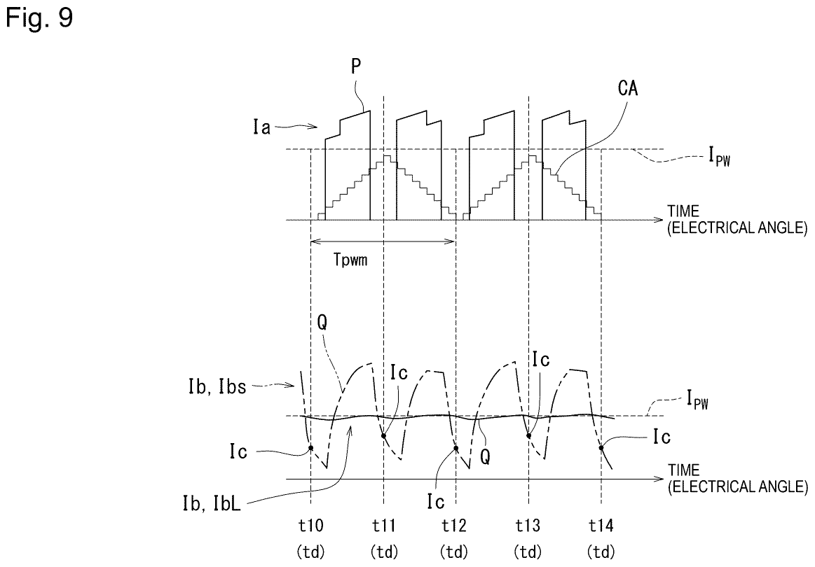

Next, the current Ia flowing through the electric resistance unit 3 and the current Ib passing through the low-pass filter 4 will be described with reference to FIGS. 1, 2, and 9. FIG. 9 is a diagram schematically illustrating a waveform of the current Ia and a waveform of the current Ib. As illustrated in FIG. 9, current IbL indicates the current Ib in a case where the time constant τ (−τL) of the low-pass filter 4 is relatively long. Current IbS indicates the current Ib in a case where the time constant τ (=τS) of the low-pass filter 4 is relatively short. For example, τL/τS=15. Note that the time constant t being long indicates that the time constant τ is large, and the time constant τ being short indicates that the time constant τ is small.

Since the currents IbL and IbS pass through the low-pass filter 4, a phase of the fluctuation component Q of the currents IbL and IbS is delayed with respect to a phase of the fluctuation component P of the current Ia.

When the time constant τ of the low-pass filter 4 is relatively long, the fluctuation component Q becomes small, so that a current value of the current IbL approximates the theoretical value Ipw of a power supply current effective value. Therefore, a detection error of a power supply current effective value by the control device 100 is relatively small. However, the time constant τ is preferably relatively short from the viewpoint of followability at the time of detection of a power supply current effective value.

On the other hand, when the time constant τ of the low-pass filter 4 is relatively short, the fluctuation component Q becomes large, and thus, a current value of the current IbS fluctuates with respect to the theoretical value Ipw of a power supply current effective value. Therefore, the current detection unit 24 detects the current Ia based on the amplified signal SA corresponding to a current value Ic of the current IbS at current detection times t10 to t14. However, by execution of averaging processing by the averaging processing unit 25 on a current value of the current Ia based on the current value Ic at the current detection times t10 to t14, stability at the time of detection of a power supply current effective value is higher than that in a case where the averaging processing unit 25 is not provided. Further, in this example, since the time constant τ of the low-pass filter 4 is relatively short, followability at the time of detection of a power supply current effective value is excellent.

In the example of FIG. 9, the current detection times t10, t12, and t14 coincide with a time when the carrier wave CA becomes the minimum value MIN. Further, the current detection times t11 and t13 coincide with a time when the carrier wave CA becomes the maximum value MAX. Hereinafter, the current detection times t10 to t14 may be collectively or individually referred to as the current detection time td.

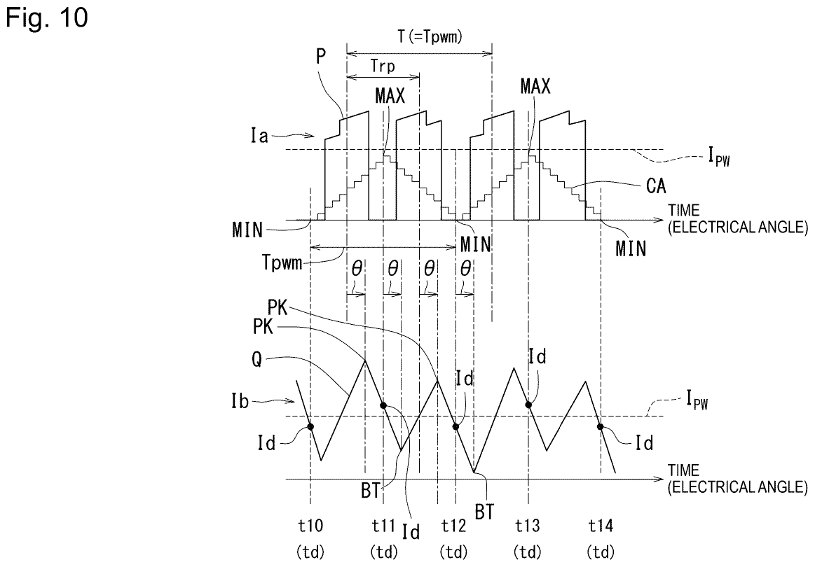

Next, a further preferable example in the first embodiment will be described with reference to FIGS. 1, 2, and 10. FIG. 10 is a diagram schematically illustrating a waveform of the current Ia and a waveform of the current Ib delayed by about 90 degrees from the current Ia. As illustrated in FIG. 10, the fluctuation component Q of the current Ib passing through the low-pass filter 4 has a phase delay angle θ of about 90 degrees with respect to the fluctuation component P of the current Ia flowing through the electric resistance unit 3. That is, the time constant τ of the low-pass filter 4 is set such that the phase delay angle θ is about 90 degrees. In this case, for example, the time constant τ is 1 ms.

The current detection unit 24 detects a current value of the current Ia based on the amplified signal SA corresponding to a current value Id of the current Ib at current detection times t10 to t14. The current value Id from the current detection times t10 to t14 indicates a value near the theoretical value Ipw of a power supply current effective value. That is, by setting the time constant τ of the low-pass filter 4 so that the phase delay angle θ is about 90 degrees, a peak PK and a bottom BT of a waveform of the current Ib passing through the low-pass filter 4 are shifted with respect to the current Ia according to the phase delay angle θ (=about 90 degrees). Therefore, the current value Id of the current Ib at the current detection times t10 to t14 approaches the theoretical value Ipw of a power supply current effective value. As a result, in a case where the time constant τ of the low-pass filter 4 is shortened, a power supply current effective value can be accurately detected. That is, it is possible to improve stability at the time of detection of a power supply current effective value while improving followability at the time of detection of a power supply current effective value.

Furthermore, the averaging processing unit 25 executes moving average processing on a current value of an even number of the currents Ia detected based on the current value Id of an even number of the currents Ib at an even number of the current detection times td. That is, the averaging processing unit 25 executes moving average processing on a current value of an even number of the currents Ia detected by the current detection unit 24. As described above, in the first embodiment, by execution of moving average processing on a current value of an even number of the currents Ia detected at the current detection time td synchronized with the maximum value MAX and the minimum value MIN of the carrier wave CA, a power supply current effective value can be accurately detected in a case where the time constant τ of the low-pass filter 4 is set to be short for symmetry of the current value Id with the theoretical value Ipw of a power supply current effective value as a symmetry axis within the PWM period Tpwm. That is, followability and stability at the time of detection of a power supply current effective value can be improved.

In this case, symmetry of the current value Id with the theoretical value Ipw of a power supply current effective value as a symmetry axis indicates that the current values Id at the current detection times td are alternately located vertically around the theoretical value Ipw on a time axis. Therefore, a power supply current effective value can be accurately detected by calculation of a moving average of current values of an even number of the currents Ia based on an even number of the current values Id.

Further, in a preferred example, the number K of samples when the averaging processing unit 25 calculates a moving average may be an even number, and is not particularly limited. For example, the averaging processing unit 25 calculates a moving average for M periods of the PWM period Tpwm. In this case, for example, in a case where two of the current detection times td are included in the PWM period Tpwm, the number K of samples is 2×M. Note that, for example, the averaging processing unit 25 calculates a moving average of the number K of samples at each of the current detection times td.

Next, as an embodiment of the present disclosure, a simulation result of an error of a detection value of a power supply current effective value will be described with reference to FIGS. 2, 11, and 12. As a simulation condition, the PWM period Tpwm was 50 μs (=0.05 ms), and the fluctuation period Trp of the current Ia flowing through the electric resistance unit 3 was 25 μs (0.025 ms). Similarly, a fluctuation period of the current Ib passing through the low-pass filter 4 was 25 μs (0.025 ms). As the current detection time td, a time when the carrier wave CA becomes the maximum value MAX and a time when the carrier wave CA becomes the minimum value MIN were set. Further, in the simulation, an error of a detection value of a power supply current effective value was an error of a detection value with respect to the theoretical value Ipw of a power supply current effective value. A detection value of a power supply current effective value was a value obtained by moving average of current values of the current Ia based on the current value Id (FIG. 10) of the current Ib. The number K of samples of moving average calculated at each of the current detection times td was “two”.

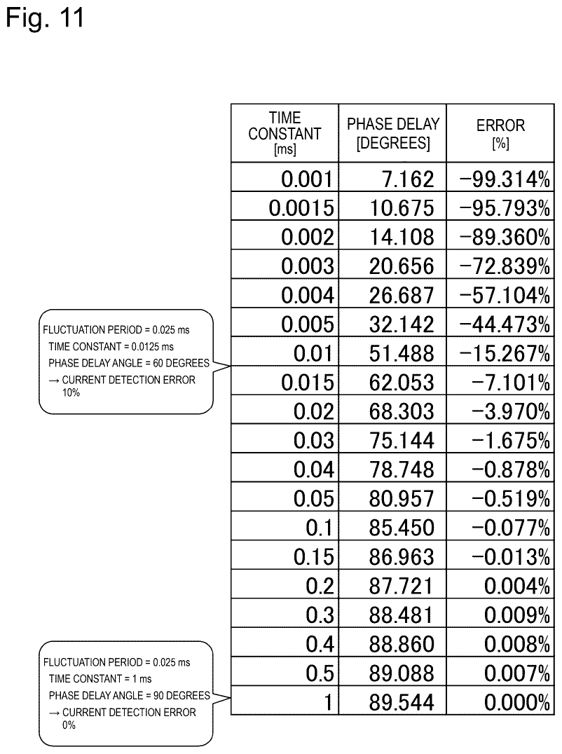

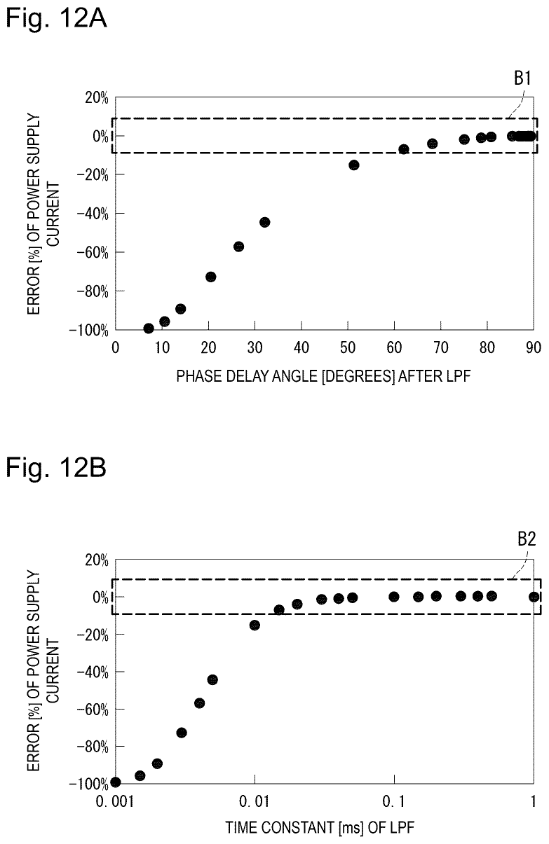

FIG. 11 is a table illustrating the time constant τ of the low-pass filter 4, the phase delay angle θ of the fluctuation component Q of the current Ib passing through the low-pass filter 4, and an error of a detection value of a power supply current effective value. FIG. 12A is a graph illustrating a relationship between the phase delay angle θ [degrees] of the fluctuation component Q of the current Ib and an error [%] of a detection value of a power supply current effective value. In FIG. 12A, a region B1 indicates a range in which an error of a detection value of a power supply current effective value is within ±10%. FIG. 12B is a graph illustrating a relationship between the time constant τ [ms] of the low-pass filter 4 and an error [%] of a detection value of a power supply current effective value. In FIG. 12B, a region B2 indicates a range in which an error of a detection value of a power supply current effective value is within ±10%.

As illustrated in FIGS. 11 and 12A, as the time constant τ of the low-pass filter 4 is set so that the phase delay angle θ of the fluctuation component Q of the current Ib becomes 60 degrees or more and 90 degrees or less, an error of a detection value of a power supply current effective value fell within 10%. Further, as the time constant τ of the low-pass filter 4 is set so that the phase delay angle θ of the fluctuation component Q of the current Ib becomes 80 degrees or more and 90 degrees or less, an error of a detection value of a power supply current effective value fell within 1%. Furthermore, as the time constant τ of the low-pass filter 4 is set so that the phase delay angle θ of the fluctuation component Q of the current Ib becomes 85 degrees or more and 90 degrees or less, an error of a detection value of a power supply current effective value fell within 0.1%. Further, as can be understood from FIG. 11, as the time constant τ of the low-pass filter 4 is made longer, the phase delay angle θ converges to about 90 degrees.

As illustrated in FIGS. 11 and 12B, as the time constant τ of the low-pass filter 4 was made longer, an error of a detection value of a power supply current effective value converged to 0%. Further, when the time constant τ of the low-pass filter 4 is 0.5 times or more the fluctuation period Trp (=0.025 ms) of the current Ia, an error of a detection value of a power supply current effective value fell within 10%.

As described above, from the simulation result illustrated in FIGS. 11, 12A, and 12B, as a preferable example of the first embodiment, the current detection unit 24 detects the current Ia at each of the current detection times td synchronized with the maximum value MAX and the minimum value MIN of the carrier wave CA for generating the PWM signal Spwm for driving the three-phase inverter 1. In addition, the time constant τ is set for the low-pass filter 4 such that the fluctuation component Q of the current Ib passing through the low-pass filter 4 has the phase delay angle θ of 60 degrees or more and 90 degrees or less with respect to the fluctuation component P of the current Ia flowing through the electric resistance unit 3. As a result, in a case where the time constant τ of the low-pass filter 4 is shortened, an error of a detection value of a power supply current effective value can be kept within 10%. That is, it is possible to improve stability at the time of detection of a power supply current effective value while improving followability at the time of detection of a power supply current effective value.

That is, in the preferred example of the first embodiment, as the phase delay angle θ of the fluctuation component Q of the current Ib that passing through the low-pass filter 4 is set to 60 degrees or more and 90 degrees or less, the peak PK and the bottom BT of a waveform of the current Ib are shifted in accordance with the phase delay angle θ with respect to the current detection time td (for example, FIG. 10). Therefore, the current value Id of the current Ib at the current detection time td approaches the theoretical value Ipw of a power supply current effective value. As a result, in a case where the time constant τ of the low-pass filter 4 is shortened, a power supply current effective value can be accurately detected.

Further, from the simulation result shown in FIGS. 11, 12A, and 12B, as a preferable example of the first embodiment, the time constant τ of the low-pass filter 4 is 0.5 times or more the fluctuation period Trp of the current Ia flowing through the electric resistance unit 3. Therefore, an error of a detection value of a power supply current effective value can be kept within 10%. That is, it is possible to realize stability at the time of detection of a power supply current effective value. In addition, the time constant τ is set for the low-pass filter 4 such that the fluctuation component Q of the current Ib passing through the low-pass filter 4 has the phase delay angle θ of 60 degrees or more and 90 degrees or less with respect to the fluctuation component P of the current Ia flowing through the electric resistance unit 3. That is, an upper limit is set to the time constant τ. Therefore, the time constant τ can be shortened, and followability at the time of detection of a power supply current effective value can be improved.

Further, in the first embodiment, the time constant τ of the low-pass filter 4 is more preferably equal to or less than overcurrent durability limit time of a circuit element through which current from the DC power supply unit PW flows. The circuit element is a circuit element constituting the control device 100. For example, the circuit element is a circuit element constituting the three-phase inverter 1. In this case, the circuit element is, for example, the first switching element SW1 and/or the second switching element SW2 (FIG. 2). The overcurrent durability limit time is time indicating a durability limit of a circuit element when overcurrent flows through a circuit element. In this preferred example, the current detection unit 24 can detect overcurrent via the electric resistance unit 3 before a durability limit of a circuit element is exceeded due to overcurrent. As a result, a circuit element can be protected by cutoff of current of the DC power supply unit PW before a durability limit of the circuit element is exceeded.

The overcurrent durability limit time is preferably 10 ms. A reason is as described below. That is, in order to reliably protect a circuit element by performing detection of overcurrent at a high speed, it is preferable to set the time constant τ equal to or less than overcurrent durability limit time of the circuit element constituting the three-phase inverter 1. For example, in many cases, a pulse width of 10 ms is defined as a longest pulse width as a safe operation region of a transistor constituting the first switching element SW1 and the second switching element SW2. In view of the above, it is functionally sufficient if overcurrent can be detected in about 10 ms. In order to reliably protect a circuit element by performing detection of overcurrent at a high speed, it is preferable to set the time constant τ shorter than fusing time of a fuse. Minimum fusing time of a fuse is often 20 ms, and overcurrent can be cut off without blowing of a fuse when the overcurrent durability limit time is 10 ms.

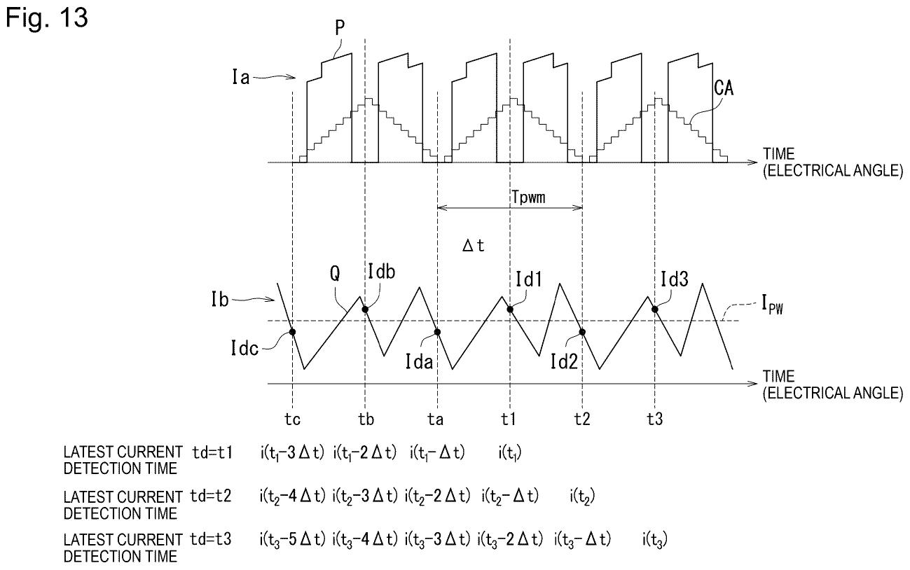

Next, an example of moving average processing by the averaging processing unit 25 will be described with reference to FIGS. 1 and 13. The averaging processing unit 25 illustrated in FIG. 1 executes moving average processing by, for example, Equation (1), Equation (2), Equation (3), or Equation (4). In Equations (1) to (4), IA1, IA2, IA3, and IA4 represent moving average values. That is, IA1, IA2, IA3, and IA4 represent power supply current effective values.

$$IA 1 = Y 1 \qquad ( 1 )$$

$$IA 2 = ( Y 1 + Y 2 ) / 2 \qquad ( 2 )$$

$$IA 3 = ( Y 1 + Y 2 + Y 3 ) / 3 \qquad ( 3 )$$

$$IA 4 = ( w 1 \times Y 1 + w 2 \times Y 2 + w 3 \times Y 3 ) / \sum wk \qquad ( 4 )$$

$$Y 1 = [ i ( tn ) + i ( tn - Δ t ) ] / 2 \qquad ( 5 )$$

$$Y 2 = [ i ( tn - 2 Δ t ) + i ( tn - 3 Δ t ) ] / 2 \qquad ( 6 )$$

$$Y 3 = [ i ( tn - 4 Δ t ) + i ( tn - 5 Δ t ) ] / 2 \qquad ( 7 )$$

Equations (1) to (3) represent a simple moving average, and Equation (4) represents a weighted moving average. In Equations (5) to (7), n represents an integer of one or more, and tn represents the latest current detection time td. A value of Δt indicates time of ½ of the PWM period Tpwm. That is, Δt indicates a time interval of the current detection time td. A value of i(tn) represents a current value of the current Ia at the time tn. A value of i(tn−Δt) represents a current value of the current Ia at a time (tn−αt). A value of i(tn−2Δt) indicates a current value of the current Ia at a time (tn−2Δt). A value of i(tn−3Δt) indicates a current value of the current Ia at a time (tn−3Δt). A value of i(tn−4Δt) indicates a current value of the current Ia at a time (tn−4Δt). A value of i(tn−5Δt) indicates a current value of the current Ia at a time (tn−5Δt). In Equation (4), w1, w2, and w3 represent a weight. A value of w1, w2, and w3 represents a real number. For example, w1>w2>w3. That is, in each term of Equation (4), a weight wk is set to be smaller as it is temporally farther from the latest current detection time td. Further, in wk, k=1, 2, or 3.

FIG. 13 is a diagram for explaining an example of moving average processing by the averaging processing unit 25. As illustrated in FIG. 13, current values i(t1), i(t2−Δt), and i(t3−2Δt) indicate current values of the current Ia detected based on a current value Id1 of the current Ib by the current detection unit 24. Current values i(t1−Δt), i(t2−2Δt), and i(t3−3Δt) indicate current values of the current Ia detected based on a current value Ida of the current Ib by the current detection unit 24. Current values i(t1−2Δt), i(t2−3Δt) and i(t3−4Δt) indicate current values of the current Ia detected based on a current value Idb of the current Ib by the current detection unit 24. Current values i(t1−3Δt), i(t2−4Δt), and i(t3−5Δt) indicate current values of the current Ia detected by the current detection unit 24 based on a current value Idc of the current Ib.

Current values i(t2) and i(t3−Δt) indicate a current value of the current Ia detected based on a current value Id2 of the current Ib by the current detection unit 24. A current value i(t3) indicates a current value of the current Ia detected based on a current value Id3 of the current Ib by the current detection unit 24.

As illustrated in FIG. 13, for example, at the latest current detection time td=t1, the averaging processing unit 25 substitutes i(t1) and i(t1−Δt) into Equation (1) to calculate a moving average value IA1.

For example, at the latest current detection time td=t2, the averaging processing unit 25 substitutes i(t2), i(t2−αt), i(t2−2Δt), and i(t2−3Δt) into Equation (2) to calculate a moving average value IA2.

For example, at the latest current detection time td=t3, the averaging processing unit 25 substitutes i(t3), i(t3−Δt), i(t3−2Δt), i(t3−3Δt), i(t3−4Δt), and i(t3=5Δt) into Equation (3) to calculate a moving average value IA3.

For example, at the latest current detection time td=t3, the averaging processing unit 25 substitutes i(t3), i(t3−Δt), i(t3−2Δt), i(t3−3Δt), i(t3−4Δt), and i(t3−5Δt) into Equation (4) to calculate a moving average value IA4.

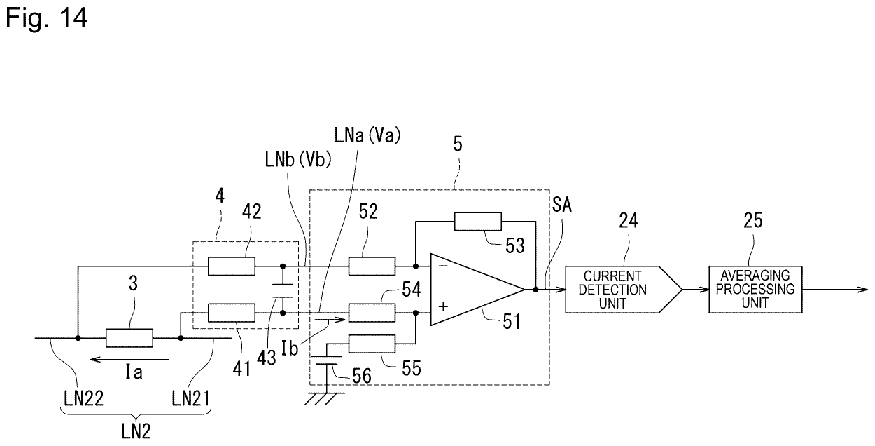

Next, an example of the low-pass filter 4 and the amplification unit 5 will be described with reference to FIG. 14. FIG. 14 is a circuit diagram illustrating the low-pass filter 4 and the amplification unit 5.

As illustrated in FIG. 14, the low-pass filter 4 includes a resistance element 41, a resistance element 42, and a capacitor 43.

One terminal of the resistance element 41 is connected to the line LN21. Specifically, one terminal of the resistance element 41 is connected to one terminal of the electric resistance unit 3. The other terminal of the resistance element 41 is connected to a line LNa. One terminal of the resistance element 42 is connected to the line LN22. Specifically, one terminal of the resistance element 42 is connected to the other terminal of the electric resistance unit 3. The other terminal of the resistance element 42 is connected to a line LNb. The capacitor 43 is connected between the line LNa and the line LNb.

The amplification unit 5 is a differential amplification unit circuit. Specifically, the amplification unit 5 includes resistance elements 52, 53, 54, and 55, a DC power supply 56, and an operational amplifier 51. One terminal of the resistance element 54 is connected to the line LNa. The other terminal of the resistance element 54 is connected to a non-inverting input terminal of the operational amplifier 51. One terminal of the resistance element 55 is connected to a non-inverting input terminal of the operational amplifier 51. The other terminal of the resistance element 55 is connected to a positive terminal of the DC power supply 56. One terminal of the resistance element 52 is connected to the line LNb. The other terminal of the resistance element 52 is connected to an inverting input terminal of the operational amplifier 51. The resistance element 53 is connected between an inverting input terminal and an output terminal of the operational amplifier 51.

The operational amplifier 51 amplifies a difference voltage (Va−Vb) between a voltage Va of a signal of the line LNa passing through the low-pass filter 4 and a voltage Vb of a signal of the line LNb passing through the low-pass filter 4, and outputs the amplified signal SA indicating the difference voltage (Va−Vb) to the current detection unit 24.

Note that a configuration of the low-pass filter 4 and the amplification unit 5 is not particularly limited as long as amplification operation can be executed by allowing a low-frequency component to pass through. For example, the low-pass filter 4 and the amplification unit 5 do not need to be clearly distinguished from each other, and an optional circuit configuration can be employed.

### (First Variation)

A first variation of the first embodiment will be described with reference to FIGS. 1, 2, and 15 to 20. The first variation is mainly different from the first embodiment in which energization in a three-phase modulation system is executed in that a two-phase modulation min-type in-phase modulation system is employed. A different point between the first variation and the first embodiment will mainly be described below.

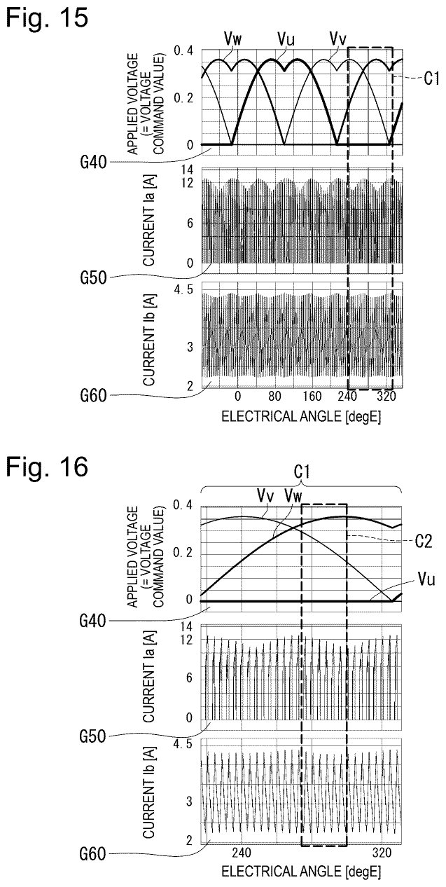

First, an example of the voltages Vu, Vv, and Vw, the current Ia, and the current Ib when energization of a two-phase modulation min-type in-phase modulation system is executed will be described with reference to FIGS. 15 to 17.

FIG. 15 is a diagram illustrating an example of waveforms of the voltages Vu, Vv, and Vw applied to each phase of the three-phase motor M3, a waveform of the current Ia flowing through the electric resistance unit 3, and a waveform of the current Ib passing through the low-pass filter 4.

As illustrated in FIG. 15, a waveform diagram G40 illustrates the voltages Vu, Vv, and Vw applied to each phase. The horizontal axis and the vertical axis of the waveform diagram G40 are similar to the horizontal axis and the vertical axis of the waveform diagram G10 illustrated in FIG. 4, respectively. Note that, in FIG. 15, the point that the lines indicating the voltages Vu, Vv, and Vw can be regarded as the lines indicating the compare values CMu, CMv, and CMw is similar to that in the first embodiment.

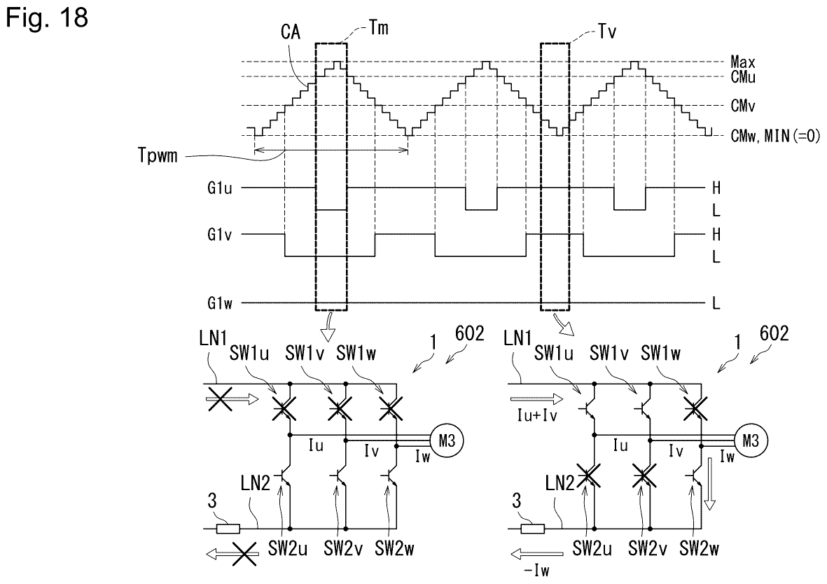

As illustrated in the waveform diagram G40, the two-phase modulation min-type in-phase modulation system is a modulation system having a period during which one phase among three phases is fixed to be turned off in a waveform of the voltages Vu, Vv, and Vw applied to each phase. In addition, in the two-phase modulation min-type in-phase modulation system, levels of two first gate signals corresponding to two non-zero compare values among the compare values CMu, CMv, and CMw are the same (FIG. 18 to be described later). The control device 100 according to the first variation executes energization in a two-phase modulation min-type in-phase modulation system.

A waveform diagram G50 illustrates a waveform of the current Ia. In the waveform diagram G50, the horizontal axis represents an electrical angle [degE], and the vertical axis represents the current Ia [A]. A waveform diagram G60 illustrates a waveform of the current Ib. In the waveform diagram G60, the horizontal axis represents an electrical angle [degE], and the vertical axis represents the current Ib [A].

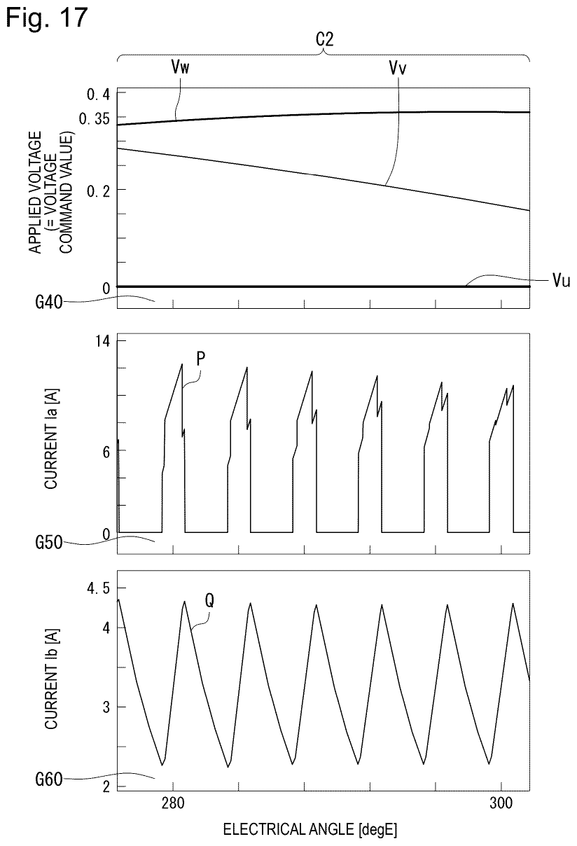

FIG. 16 is an enlarged diagram of a region C1 in FIG. 15. FIG. 17 is an enlarged diagram of a region C2 in FIG. 16. As illustrated in FIGS. 16 and 17, in the current Ib, a high-frequency component is removed from the current Ia by an action of the low-pass filter 4. Further, as illustrated in FIG. 17, the current Ia includes a plurality of the fluctuation components P. The fluctuation component P of the current Ia is generated mainly due to switching operation of the first switching element SW1 and the second switching element SW2 illustrated in FIG. 2. Similarly, the current Ib includes a plurality of the fluctuation components Q. The fluctuation component Q corresponds to the fluctuation component P.

Next, before detailed description of the control device 100 of the first variation, a control device 602 according to a second comparative example will be described with reference to FIG. 18 in order to facilitate understanding. As compared with the control device 100 of FIG. 1, the control device 602 does not include the averaging processing unit 25 or the low-pass filter 4. Other configurations of the control device 602 are similar to those of the control device 100. Therefore, in description of each configuration of the control device 602, a reference numeral attached to each configuration of the control device 100 is appropriately used.

FIG. 18 is a diagram for explaining operation of the control device 602 according to the second comparative example. Note that, in FIG. 18, the rectifier element D is omitted for simplification of the diagram.

As illustrated in FIG. 18, in the period Tm including the maximum value MAX of the carrier wave CA, the first gate signals G1u, G1v, and G1w are at a low level. Therefore, in the three-phase inverter 1 of the control device 602, the first switching elements SW1u, SW1v, and SW1w are turned off. As a result, in the period Tm, no current flows through the electric resistance unit 3. Therefore, in the period Tm, a power supply current effective value cannot be detected. Therefore, in the first variation, the control device 100 includes the low-pass filter 4 and the averaging processing unit 25 to delay a phase of current and execute the averaging processing, so that detection of a power supply current effective value in the period Tm is enabled.

Further, in the period Tv including the minimum value MIN of the carrier wave CA, the first gate signals G1u and G1v are at a high level, and the second gate signals G2u and G2v (not illustrated) are at a low level. Further, in the period Tv, the first gate signal G1w is at a low level, and the second gate signal G2w (not illustrated) is at a high level. Therefore, in the three-phase inverter 1 of the control device 602, the first switching elements SW1u and SW1v are turned on, and the second switching element SW2w is turned on. As a result, in the period Tv, current (−Iw) flows from the second switching element SW2w to the electric resistance unit 3. That is, only one phase current flows through the electric resistance unit 3, and a power supply current effective value cannot be detected. Therefore, in the first variation, the control device 100 includes the low-pass filter 4 and the averaging processing unit 25 to delay a phase of current and execute the averaging processing, so that detection of a power supply current effective value in the period Tv is enabled.

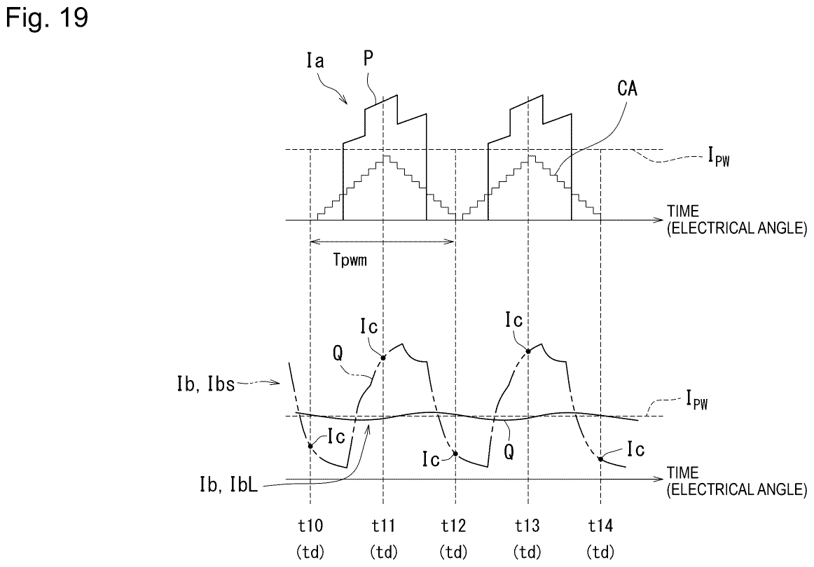

Next, the current Ia flowing through the electric resistance unit 3 and the current Ib passing through the low-pass filter 4 will be described with reference to FIGS. 1, 2, and 19. FIG. 19 is a diagram schematically illustrating a waveform of the current Ia and a waveform of the current Ib. As illustrated in FIG. 19, the current IbL indicates the current Ib in a case where the time constant τ (=τL) of the low-pass filter 4 is relatively long. The current IbS indicates the current Ib in a case where the time constant τ (=τS) of the low-pass filter 4 is relatively short. For example, τL/τS=15.

Since the currents IbL and IbS pass through the low-pass filter 4, a phase of the fluctuation component Q of the currents IbL and IbS is delayed with respect to a phase of the fluctuation component P of the current Ia.

When the time constant τ of the low-pass filter 4 is relatively long, the fluctuation component Q becomes small, so that a current value of the current IbL approximates the theoretical value Ipw of a power supply current effective value. Therefore, a detection error of a power supply current effective value by the control device 100 is relatively small. However, the time constant τ is preferably relatively short from the viewpoint of followability at the time of detection of a power supply current effective value.

On the other hand, when the time constant τ of the low-pass filter 4 is relatively short, the fluctuation component Q becomes large, and thus, a current value of the current IbS fluctuates with respect to the theoretical value Ipw of a power supply current effective value. Therefore, the current detection unit 24 detects the current Ia based on the amplified signal SA corresponding to the current value Ic of the current IbS at the current detection times t10 to t14. However, by execution of averaging processing by the averaging processing unit 25 on a current value of the current Ia based on the current value Ic at the current detection times t10 to t14, stability at the time of detection of a power supply current effective value is higher than that in a case where the averaging processing unit 25 is not provided. Further, in this example, since the time constant τ of the low-pass filter 4 is relatively short, followability at the time of detection of a power supply current effective value is excellent.

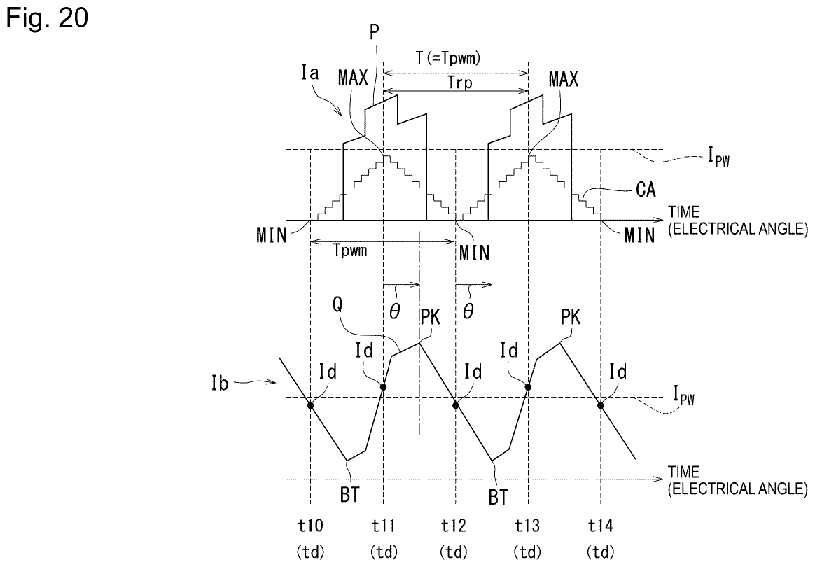

Next, a further preferable example in the first variation will be described with reference to FIGS. 1, 2, and 20. FIG. 20 is a diagram schematically illustrating a waveform of the current Ia and a waveform of the current Ib delayed by about 90 degrees from the current Ia. As illustrated in FIG. 20, the fluctuation period Trp of the current Ia coincides with the period T. A length of the period T is the same as a length of the PWM period Tpwm. The fluctuation period Trp indicates a period of the fluctuation component P. Specifically, when a waveform of the current Ia is subjected to Fourier series expansion, since amplitude of a primary component is the largest, a period T1 (not illustrated) of the primary component becomes the fluctuation period Trp. T1=Tpwm×(1/J)=Tpwm×(1/1). J represents an order.

Further, the fluctuation component Q of the current Ib passing through the low-pass filter 4 has the phase delay angle θ of about 90 degrees with respect to the fluctuation component P of the current Ia flowing through the electric resistance unit 3. That is, the time constant τ of the low-pass filter 4 is set such that the phase delay angle θ is about 90 degrees. In this case, for example, the time constant τ is 1 ms.

The current detection unit 24 detects a current value of the current Ia based on the amplified signal SA corresponding to the current value Id of the current Ib at the current detection times t10 to t14. The current value Id from the current detection times t10 to t14 indicates a value near the theoretical value Ipw of a power supply current effective value. That is, by setting the time constant τ of the low-pass filter 4 so that the phase delay angle θ is about 90 degrees, the peak PK and the bottom BT of a waveform of the current Ib passing through the low-pass filter 4 are shifted with respect to the current detection times t10 to t14 according to the phase delay angle θ (=about 90 degrees). Therefore, the current value Id of the current Ib at the current detection times t10 to t14 approaches the theoretical value Ipw of a power supply current effective value. As a result, in a case where the time constant τ of the low-pass filter 4 is shortened, a power supply current effective value can be accurately detected. The averaging processing will be described later.

### (Second Variation)

A second variation of the first embodiment will be described with reference to FIGS. 1, 2, and 21 to 26. The second variation is mainly different from the first embodiment in which energization in a three-phase modulation system is executed in that a two-phase modulation min-type reverse-phase modulation system is employed. A different point between the second variation and the first embodiment will mainly be described below.

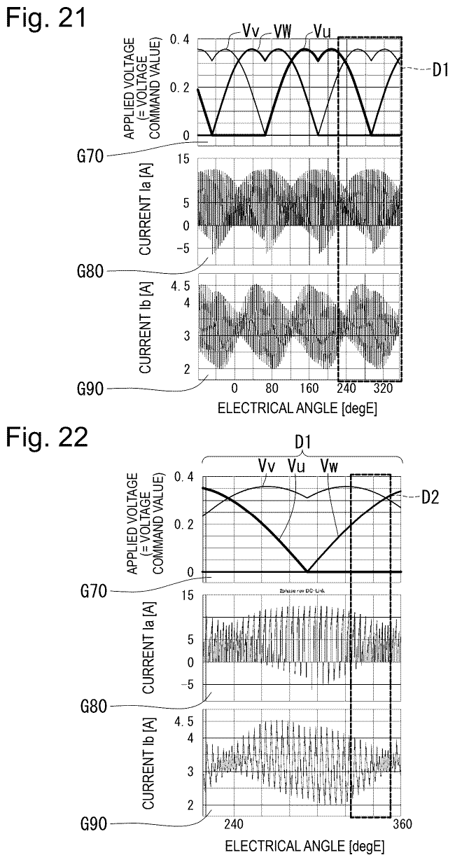

First, an example of the voltages Vu, Vv, and Vw, the current Ia, and the current Ib when energization of a two-phase modulation min-type reverse-phase modulation system is executed will be described with reference to FIGS. 21 to 23.

FIG. 21 is a diagram illustrating an example of waveforms of the voltages Vu, Vv, and Vw applied to each phase of the three-phase motor M3, a waveform of the current Ia flowing through the electric resistance unit 3, and a waveform of the current Ib passing through the low-pass filter 4.

As illustrated in FIG. 21, a waveform diagram G70 illustrates the voltages Vu, Vv, and Vw applied to each phase. The horizontal axis and the vertical axis of the waveform diagram G70 are similar to the horizontal axis and the vertical axis of the waveform diagram G10 illustrated in FIG. 4, respectively. Note that, in FIG. 21, the point that the lines indicating the voltages Vu, Vv, and Vw can be regarded as the lines indicating the compare values CMu, CMv, and CMw is similar to that in the first embodiment.

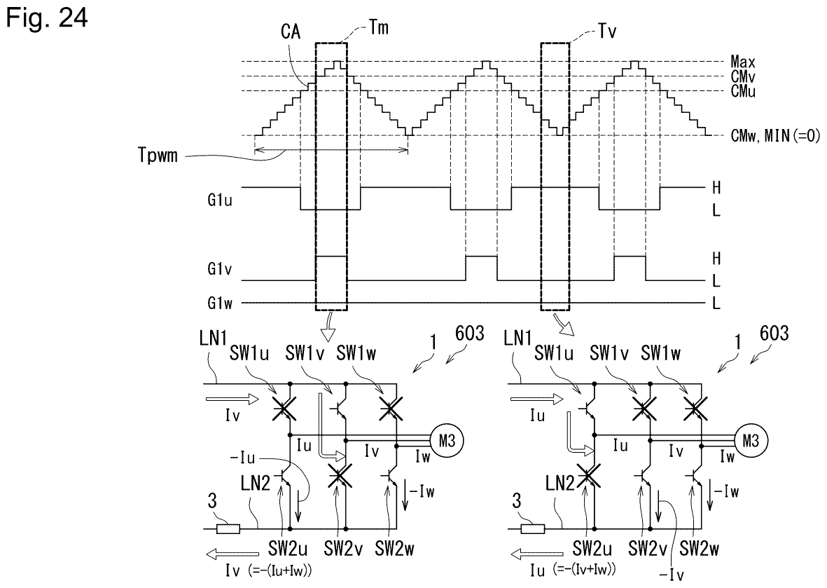

As illustrated in the waveform diagram G70, the two-phase modulation min-type reverse-phase modulation system is a modulation system having a period during which one phase among three phases is fixed to be turned off in a waveform of the voltages Vu, Vv, and Vw applied to each phase. In addition, in the two-phase modulation min-type reverse-phase modulation system, levels of two first gate signals corresponding to two non-zero compare values among the compare values CMu, CMv, and CMw are opposite (FIG. 24 to be described later). The control device 100 according to the second variation executes energization in a two-phase modulation min-type reverse-phase modulation system.

A waveform diagram G80 illustrates a waveform of the current Ia. In the waveform diagram G80, the horizontal axis represents an electrical angle [degE], and the vertical axis represents the current Ia [A]. A waveform diagram G90 illustrates a waveform of the current Ib. In the waveform diagram G90, the horizontal axis represents an electrical angle [degE], and the vertical axis represents the current Ib [A].

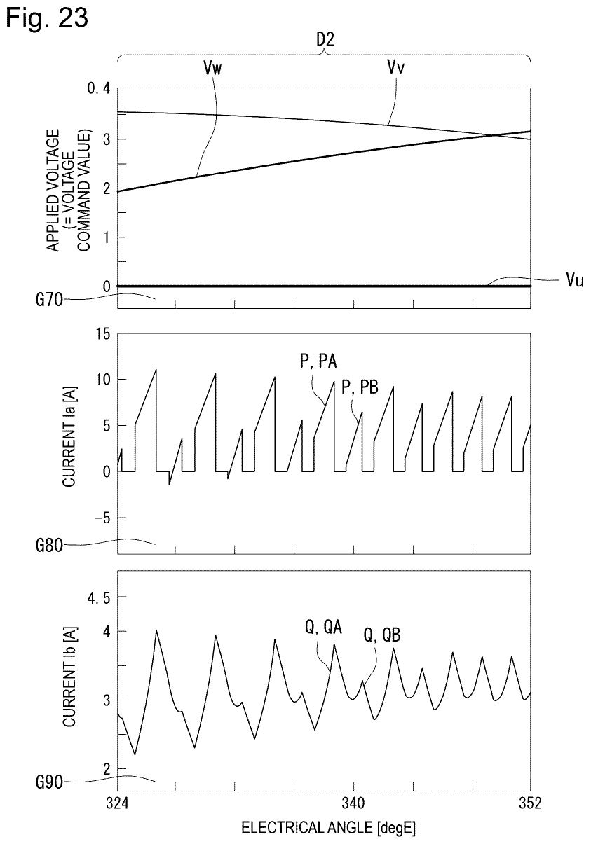

FIG. 22 is an enlarged diagram of a region D1 in FIG. 21. FIG. 23 is an enlarged diagram of a region D2 in FIG. 22. As illustrated in FIGS. 22 and 23, in the current Ib, a high-frequency component is removed from the current Ia by an action of the low-pass filter 4. Further, as illustrated in FIG. 23, the current Ia includes a plurality of the fluctuation components P. For example, the current Ia alternately includes the fluctuation component PA and the fluctuation component PB. The fluctuation component P of the current Ia is generated mainly due to switching operation of the first switching element SW1 and the second switching element SW2 illustrated in FIG. 2. Similarly, the current Ib includes a plurality of the fluctuation components Q. For example, the current Ib alternately includes the fluctuation component QA and the fluctuation component QB. The fluctuation component QA corresponds to the fluctuation component PA. The fluctuation component QB corresponds to the fluctuation component PB.

Next, before detailed description of the control device 100 of the second variation, a control device 603 according to a third comparative example will be described with reference to FIG. 24 in order to facilitate understanding. As compared with the control device 100 of FIG. 1, the control device 603 does not include the averaging processing unit 25 or the low-pass filter 4. Other configurations of the control device 603 are similar to those of the control device 100. Therefore, in description of each configuration of the control device 603, a reference numeral attached to each configuration of the control device 100 is appropriately used.

FIG. 24 is a diagram for explaining operation of the control device 603 according to the third comparative example. Note that, in FIG. 24, the rectifier element D is omitted for simplification of the diagram.

As illustrated in FIG. 24, in the period Tm including the maximum value MAX of the carrier wave CA, the first gate signal G1v is at a high level, and the second gate signal G2v (not illustrated) is at a low level. Further, in the period Tv, the first gate signals G1u and G1w are at a low level, and the second gate signals G2u and G2w (not illustrated) are at a high level. Therefore, in the three-phase inverter 1 of the control device 603, the first switching element SW1w is turned on, and the second switching elements SW2u and SW2w are turned on. As a result, in the period Tm, the current Iv (=−(Iu+Iw)) flows from the second switching elements SW2u and SW2w to the electric resistance unit 3. That is, only the phase current Iv flows through the electric resistance unit 3, and a power supply current effective value cannot be detected. Therefore, in the second variation, the control device 100 includes the low-pass filter 4 and the averaging processing unit 25 to delay a phase of current and execute the averaging processing, so that detection of a power supply current effective value in the period Tm is enabled.

Further, in the period Tv including the minimum value MIN of the carrier wave CA, the first gate signal G1u is at a high level, and the second gate signal G2u (not illustrated) is at a low level. Further, in the period Tv, the first gate signals G1v and G1w are at a low level, and the second gate signals G2v and G2w (not illustrated) are at a high level. Therefore, in the three-phase inverter 1 of the control device 603, the first switching element SW1u is turned on, and the second switching elements SW2v and SW2w are turned on. As a result, in the period Tv, the current Iu (=−(Iv+Iw)) flows from the second switching elements SW2v and SW2w to the electric resistance unit 3. That is, only the phase current Iu flows through the electric resistance unit 3, and a power supply current effective value cannot be detected. Therefore, in the second variation, the control device 100 includes the low-pass filter 4 and the averaging processing unit 25 to delay a phase of current and execute the averaging processing, so that detection of a power supply current effective value in the period Tv is enabled.

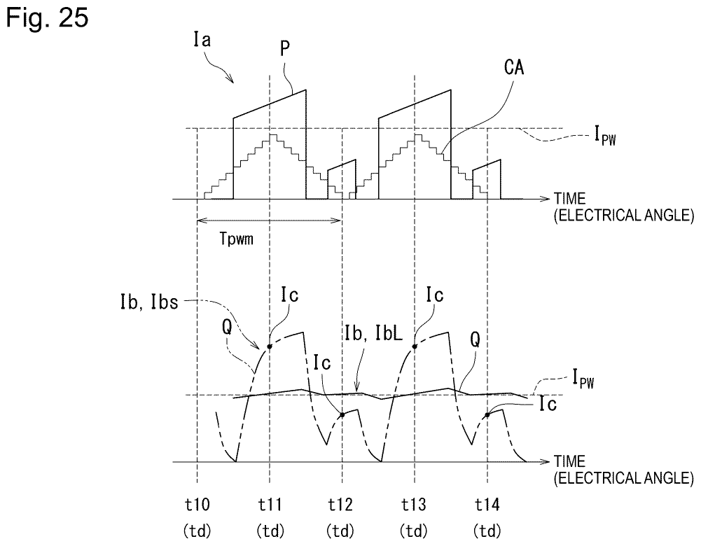

Next, the current Ia flowing through the electric resistance unit 3 and the current Ib passing through the low-pass filter 4 will be described with reference to FIGS. 1, 2, and 25. FIG. 25 is a diagram schematically illustrating a waveform of the current Ia and a waveform of the current Ib. As illustrated in FIG. 25, the current IbL indicates the current Ib in a case where the time constant τ (=τL) of the low-pass filter 4 is relatively long. The current IbS indicates the current Ib in a case where the time constant τ (=τS) of the low-pass filter 4 is relatively short. For example, τL/τS=15.

Since the currents IbL and IbS pass through the low-pass filter 4, a phase of the fluctuation component Q of the currents IbL and IbS is delayed with respect to a phase of the fluctuation component P of the current Ia.

When the time constant τ of the low-pass filter 4 is relatively long, the fluctuation component Q becomes small, so that a current value of the current IbL approximates the theoretical value Ipw of a power supply current effective value. Therefore, a detection error of a power supply current effective value by the control device 100 is relatively small. However, the time constant τ is preferably relatively short from the viewpoint of followability at the time of detection of a power supply current effective value.

On the other hand, when the time constant τ of the low-pass filter 4 is relatively short, the fluctuation component Q becomes large, and thus, a current value of the current IbS fluctuates with respect to the theoretical value Ipw of a power supply current effective value. Therefore, the current detection unit 24 detects the current Ia based on the amplified signal SA corresponding to the current value Ic of the current IbS at the current detection times t10 to t14. However, by execution of averaging processing by the averaging processing unit 25 on a current value of the current Ia based on the current value Ic at the current detection times t10 to t14, stability at the time of detection of a power supply current effective value is higher than that in a case where the averaging processing unit 25 is not provided. Further, in this example, since the time constant τ of the low-pass filter 4 is relatively short, followability at the time of detection of a power supply current effective value is excellent.

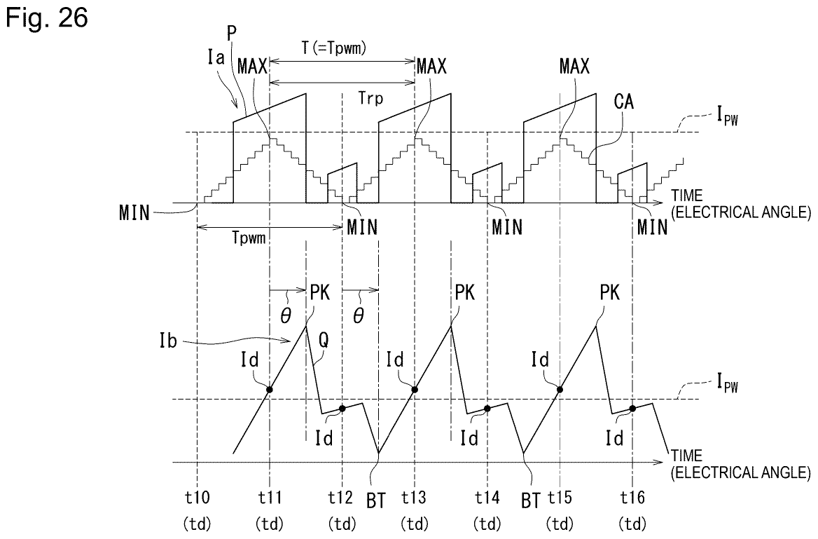

Next, a further preferable example in the second variation will be described with reference to FIGS. 1, 2, and 26. FIG. 26 is a diagram schematically illustrating a waveform of the current Ia and a waveform of the current Ib delayed by about 90 degrees from the current Ia. As illustrated in FIG. 26, the fluctuation period Trp of the current Ia coincides with the period T. A length of the period T is the same as a length of the PWM period Tpwm. The fluctuation period Trp indicates a period of the fluctuation component P. Specifically, when a waveform of the current Ia is subjected to Fourier series expansion, since amplitude of a primary component is the largest, the period T1 (not illustrated) of the primary component becomes the fluctuation period Trp. T1=Tpwm×(1/J)=Tpwm×(1/1). J represents an order.

Further, the fluctuation component Q of the current Ib passing through the low-pass filter 4 has the phase delay angle θ of about 90 degrees with respect to the fluctuation component P of the current Ia flowing through the electric resistance unit 3. That is, the time constant τ of the low-pass filter 4 is set such that the phase delay angle θ is about 90 degrees. In this case, for example, the time constant τ is 1 ms.

The current detection unit 24 detects a current value of the current Ia based on the amplified signal SA corresponding to the current value Id of the current Ib at the current detection times t10 to t14. The current value Id from the current detection times t10 to t14 indicates a value near the theoretical value Ipw of a power supply current effective value. That is, by setting the time constant τ of the low-pass filter 4 so that the phase delay angle θ is about 90 degrees, the peak PK and the bottom BT of a waveform of the current Ib passing through the low-pass filter 4 are shifted with respect to the current detection times t10 to t14 according to the phase delay angle θ (=about 90 degrees). Therefore, the current value Id of the current Ib at the current detection times t10 to t14 approaches the theoretical value Ipw of a power supply current effective value. As a result, in a case where the time constant τ of the low-pass filter 4 is shortened, a power supply current effective value can be accurately detected.

Here, with reference to FIGS. 20 and 26, also in the first variation and the second variation, similarly to the first embodiment, the averaging processing unit 25 executes moving average processing on a current value of an even number of the currents Ia detected based on the current value Id of an even number of the currents Ib at an even number of the current detection times td. That is, in the first variation and the second variation, similarly to the first embodiment, the averaging processing unit 25 executes moving average processing on a current value of an even number of the currents Ia detected by the current detection unit 24. In addition, the moving average processing is similar to the moving average processing of the first embodiment.

Further, regarding a simulation of an error of a detection value of a power supply current effective value, it can be estimated that the same result as that of the three-phase modulation method (first embodiment) can be obtained also in a two-phase modulation min-type in-phase modulation system (first variation) and a two-phase modulation min-type reverse-phase modulation system (second variation). This is because the first embodiment differs from the first variation and the second variation only in a modulation system, but a configuration of the low-pass filter 4 is the same.

Therefore, in the first variation and the second variation, similarly to the first embodiment, the current detection unit 24 preferably detects the current Ia at each of the current detection times td synchronized with the maximum value MAX and the minimum value MIN of the carrier wave CA. In addition, the time constant τ is preferably set for the low-pass filter 4 such that the fluctuation component Q of the current Ib passing through the low-pass filter 4 has the phase delay angle θ of 60 degrees or more and 90 degrees or less with respect to the fluctuation component P of the current Ia flowing through the electric resistance unit 3. Furthermore, in the first variation and the second variation, similarly to the first embodiment, the time constant τ of the low-pass filter 4 is preferably 0.5 times or more the fluctuation period Trp of the current Ia flowing through the electric resistance unit 3. Furthermore, in the first variation and the second variation, similarly to the first embodiment, the time constant τ of the low-pass filter 4 is preferably equal to or less than overcurrent durability limit time of a circuit element through which current from the DC power supply unit PW flows. The overcurrent durability limit time is preferably 10 ms.

### Second Embodiment

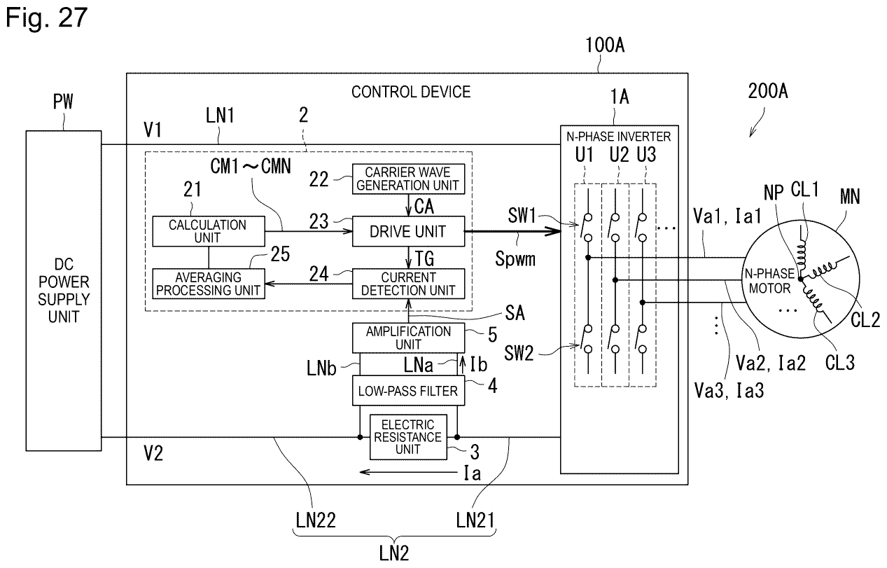

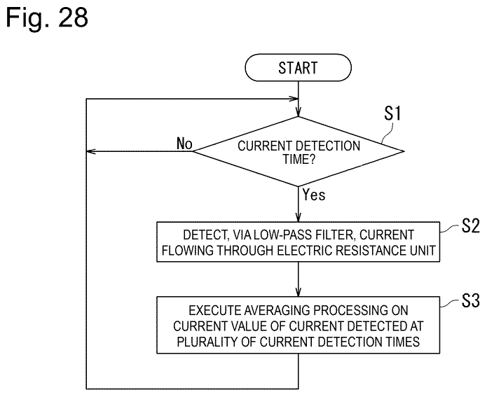

A motor module 200A according to a second embodiment of the present invention will be described with reference to FIGS. 27 and 28. The second embodiment is mainly different from the first embodiment in that the motor module 200A according to the second embodiment controls an N-phase inverter 1A. Hereinafter, a difference of the second embodiment from the first embodiment will be mainly described.

FIG. 27 is a block diagram illustrating the motor module 200A according to the second embodiment. As illustrated in FIG. 27, the motor module 200A includes a control device 100A and an N-phase motor MN. In the present specification, “N” represents an integer of three or more. The control device 100A controls the N-phase inverter 1A that applies voltages Va1 to VaN to N phases when N is an integer of three or more. In the example of FIG. 27, the control device 100A includes the N-phase inverter 1A. Then, the N-phase inverter 1A is connected to the DC power supply unit PW.

In the present description, as an example, the N-phase inverter 1A applies the voltages Va1 to VaN having different phases to each phase of the N-phase motor MN to drive the N-phase motor MN. Hereinafter, the voltages Va1 to VaN may be referred to as the applied voltages Va1 to VaN. Further, the voltages Va1 to VaN may be collectively or individually referred to as “phase voltage”. Currents Ia1 to IaN corresponding to the voltages Va1 to VaN flow through phases of the N-phase motor MN. Hereinafter, the currents Ia1 to IaN may be collectively or individually referred to as “phase currents”.

The N-phase motor MN includes coils CL1 to CLN of N phases. The currents Ia1 to IaN flow through the coils CL1 to CLN, respectively. The N-phase motor MN is, for example, a brushless DC motor. The N-phase motor MN has P1 to PN phases. With respect to polarity of the currents Ia1 to IaN, polarity of current flowing from the N-phase inverter 1A to the neutral point NP of the N-phase motor MN is set to positive, and polarity of current flowing from the neutral point NP to the N-phase inverter 1A is set to negative.

Note that a driving target of the N-phase inverter 1A is not limited to the N-phase motor MN, and may be another electric device. Further, the N-phase motor MN may be arranged outside the control device 100A.

The control device 100A further includes the electric resistance unit 3, the low-pass filter 4, the current detection unit 24, and the averaging processing unit 25. Specifically, the control device 100A includes the inverter control unit 2. The inverter control unit 2 controls the N-phase inverter 1A. Then, the inverter control unit 2 includes the current detection unit 24 and the averaging processing unit 25.

The low-pass filter 4 has a frequency characteristic corresponding to the time constant τ. The current detection unit 24 detects current Ia flowing through the electric resistance unit 3 connected between the DC power supply unit PW and the N-phase inverter 1 via the low-pass filter 4. The averaging processing unit 25 executes averaging processing on a current value of the current Ia detected by the current detection unit 24 at a plurality of the current detection times td. Therefore, influence of a fluctuation component included in the current Ia can be reduced. Directly, influence of a fluctuation component included in the current Ib that passes through the low-pass filter 4 can be reduced by averaging processing.

As a result, according to the second embodiment, the control device 100A can accurately detect an effective value (power supply current effective value) of power supply current from the DC power supply unit PW while reducing dependency on performance of the current detection unit 24. That is, in a case where performance of the current detection unit 24 is relatively low, a power supply current effective value can be accurately detected. A current value of the current Ia after averaging processing corresponds to a power supply current effective value. Further, in the second embodiment, similarly to the first embodiment, both stability and followability at the time of detection of a power supply current effective value can be realized. In addition, operation of the control device 100A of the second embodiment is similar to operation of the control device 100 of the first embodiment.

Next, a control method according to the second embodiment will be described with reference to FIGS. 27 and 28. The control method is executed by the control device 100A that controls the N-phase inverter 1A when N is an integer of three or more.

FIG. 28 is a flowchart illustrating a control method according to the second embodiment. As illustrated in FIG. 28, the control method includes Steps S1 to S3.

As illustrated in FIGS. 27 and 28, first, in Step S1, the current detection unit 24 determines whether or not the current detection time td has come. That is, the current detection unit 24 determines whether or not the drive unit 23 outputs the trigger TG.

When it is determined in Step S1 that the current detection time td has not come (No), the processing repeats Step S1.

On the other hand, when it is determined in Step S1 that the current detection time td has come (Yes), the processing proceeds to Step S2.

Next, in Step S2, the current detection unit 24 detects the current Ia flowing through the electric resistance unit 3 connected between the DC power supply unit PW and the N-phase inverter 1A via the low-pass filter 4. Step S2 corresponds to an example of “current detection step”.

Next, in Step S3, the averaging processing unit 25 executes averaging processing on a current value of the current Ia detected in Step S2 at a plurality of the current detection times td. Preferably, the averaging processing is moving average processing. After completion of Step S3, the processing proceeds to Step S1. Step S3 corresponds to an example of “averaging processing step”.

As described above with reference to FIG. 28, in the control method according to the second embodiment, influence of a fluctuation component included in the current Ia can be reduced by execution of averaging processing. Directly, influence of a fluctuation component included in the current Ib that passes through the low-pass filter 4 can be reduced by averaging processing. As a result, according to the control method according to the second embodiment, a power supply current effective value can be accurately detected while dependency on performance of the current detection unit 24 is reduced. Further, both stability and followability at the time of detection of a power supply current effective value can be realized.

Returning to FIG. 27, the control device 100A will be described. The N-phase inverter 1A includes N switching units U1 to UN.

The N switching units U1 to UN apply the voltages Va1 to VaN to N phases. Specifically, the N switching units U1 to UN apply the voltages Va1 to VaN in different phases to the coils CL1 to CLN of N phases, respectively.

Each of the switching units U1 to UN includes the first switching element SW1 on the first voltage V1 side of the DC power supply unit PW and the second switching element SW2 on the second voltage V2 side of the DC power supply unit PW. The PWM signal Spwm includes N first gate signals G11 to G1N (not illustrated) that drive the first switching elements SW1 of the switching units U1 to UN, respectively, and N second gate signals G21 to G2N (not illustrated) that drive the second switching elements SW2 of the switching units U1 to UN, respectively.

The calculation unit 21 calculates voltage command values Vb1 to VbN (not illustrated). When N of phases constituting the N phases are “P1 phase to PN phase”, the calculation unit 21 calculates the voltage command values Vb1 to VbN corresponding to the P1 phase to the PN phase, respectively. The voltage command values Vb1 to VbN indicate voltage values of the voltages Va1 to VaN output from the N-phase inverter 1A, respectively. Therefore, the voltage command values Vb1 to VbN substantially coincide with voltage values of the voltages Va1 to VaN output from the N-phase inverter 1A, respectively. Specifically, the voltage command values Vb1 to VbN indicate voltage values to be followed by the voltages Va1 to VaN applied to the P1 to PN phases constituting the N phases, respectively. In the present description, the voltage command values Vb1 to VbN and the applied voltages Va1 to VaN are substantially synonymous.

The calculation unit 21 calculates compare values CM1 to CMN based on the voltage command values Vb1 to VbN. Therefore, the compare values CM1 to CMN correspond to the voltage command values Vb1 to VbN, respectively. The compare values CM1 to CMN directly or indirectly indicate a duty value of the first gate signals G11 to G1N in the PWM signal Spwm. The calculation unit 21 outputs the compare values CM1 to CMN to the drive unit 23.

The carrier wave generation unit 22 generates the carrier wave CA. The carrier wave generation unit 22 outputs the carrier wave CA to the drive unit 23.

The drive unit 23 compares each of the compare values CM1 to CMN with the carrier wave CA, and generates the PWM signal Spwm based on a comparison result. Specifically, the drive unit 23 determines whether or not a compare value is equal to or more than a level of the carrier wave CA for each of the compare values CM1 to CMN. Then, the drive unit 23 sets each of the first gate signals G11 to G1N and each of the second gate signals G21 to G2N in the PWM signal Spwm to a high level or a low level based on a determination result for each of the compare values CM1 to CMN.

The embodiments of the present invention are described above with reference to the drawings. However, the present invention is not limited to the above embodiments, and can be implemented in various aspects in a range not departing from the gist of the present invention. Further, a plurality of constituent elements disclosed in the above embodiments can be appropriately modified. For example, one constituent element of all constituent elements illustrated in one embodiment may be added to a constituent element of another embodiment, or some constituent elements of all components illustrated in one embodiment may be eliminated from the embodiment.

Further, the drawings schematically illustrate each constituent element mainly in order to facilitate understanding of the invention, and the thickness, length, number, interval, and the like of the illustrated constituent elements may be different from the actual ones for convenience of creation of the drawings. Further, a configuration of each constituent element illustrated in the above embodiment is an example and is not particularly limited, and it goes without saying that various modifications can be made without substantially departing from the effect of the present invention.

For example, in FIGS. 10, 20, and 26, the current detection unit 24 detects the current Ia at the current detection time td synchronized with the maximum value MAX and the minimum value MIN of the carrier wave CA. In this case, as long as the current detection time td deviates from a generation timing of the switching noise NZ, the current detection time td does not need to completely coincide with the maximum value MAX and the minimum value MIN of the carrier wave CA. For example, as long as the current detection time td is synchronized with the maximum value MAX and the minimum value MIN of the carrier wave CA, the current detection time td may be a time earlier than the maximum value MAX and the minimum value MIN of the carrier wave CA or a time later than the maximum value MAX and the minimum value MIN of the carrier wave CA on a time axis.

For example, the current detection time td may be set such that a time when the carrier wave CA becomes the maximum value MAX is substantially a midpoint of the sampling period Ts in the sample hold unit 241. In addition, for example, the current detection time td may be set such that a time when the carrier wave CA becomes the minimum value MIN is substantially a midpoint of the sampling period Ts in the sample hold unit 241. In these examples, influence of the switching noise NZ can be further reduced.

For example, in the present disclosure, a modulation system is not limited to a three-phase modulation system, a two-phase modulation min-type in-phase modulation system, and a two-phase modulation min-type reverse-phase modulation system, and an optional modulation system can be employed. For example, a two-phase modulation min-max-type modulation system can be employed.

### INDUSTRIAL APPLICABILITY

The present invention can be suitably used for a control device, a motor module, and a control method.

1. A control device that controls an N-phase inverter when N is an integer of three or more, the control device comprising:
a low-pass filter having a frequency characteristic according to a time constant;
a current detection unit that detects, via the low-pass filter, current flowing through an electric resistance unit connected between a DC power supply unit and the N-phase inverter; and
an averaging processing unit that executes averaging processing on a current value of the current detected by the current detection unit at a plurality of current detection times.

2. The control device according to claim 1, wherein the N is three.

3. The control device according to claim 2, wherein
the time constant is 0.5 times or more a fluctuation period of the current flowing through the electric resistance unit, and
the time constant is set for the low-pass filter so that a fluctuation component of current that passes through the low-pass filter has a phase delay angle of 60 degrees or more and 90 degrees or less with respect to a fluctuation component of the current flowing through the electric resistance unit.

4. The control device according to claim 3, wherein
the time constant is equal to or less than overcurrent durability limit time of a circuit element through which current from the DC power supply unit flows, and
the overcurrent durability limit time is time indicating a durability limit of the circuit element when overcurrent flows through the circuit element.

5. The control device according to claim 2, wherein the current detection unit detects the current at the current detection time synchronized with a maximum value and a minimum value of a carrier wave for generating a PWM signal for driving the N-phase inverter.

6. The control device according to claim 2, wherein
the current detection unit detects the current at the current detection time synchronized with a maximum value and a minimum value of a carrier wave for generating a PWM signal for driving the N-phase inverter, and
the time constant is set for the low-pass filter so that a fluctuation component of current that passes through the low-pass filter has a phase delay angle of 60 degrees or more and 90 degrees or less with respect to a fluctuation component of the current flowing through the electric resistance unit.

7. The control device according to claim 5, wherein the averaging processing unit executes moving average processing on a current value of an even number of the currents detected by the current detection unit.

8. The control device according to claim 1, wherein the averaging processing unit performs moving average processing on a current value of the current detected at the plurality of current detection times.

9. A motor module comprising:
the control device according to claim 1; and
a motor driven by an N-phase inverter controlled by the control device when N is an integer of three or more.

10. A control method executed by a control device that controls an N-phase inverter when N is an integer of three or more, the control method comprising:
a current detection step of detecting, via a low-pass filter, current flowing through an electric resistance unit connected between a DC power supply unit and the N-phase inverter; and
an averaging processing step of executing averaging processing on a current value of the current detected by the current detection step at a plurality of current detection times.
